(19) United States
(12) Patent Application Publication
(10) Pub. No.: US 2002/0007453 A1
(43) Pub. Date: Jan. 17, 2002

(54) Secured electronic mail system and method

(76) Inventor: C. Kerry Nemovicher, Englewood, NJ (US)

Correspondence Address: OSTROLENK FABER GERB & SOFFEN, 1180 AVENUE OF THE AMERICAS, NEW YORK, NY, 100368403

(21) Appl. No.: 09/862,957

(22) Filed: May 22, 2001

Related U.S. Application Data
(60) Provisional application No. 60/206,580, filed on May 23, 2000.

(51) Int. Cl. H04L 9/00; G06F 15/167

(52) U.S. Cl. 713/155; 713/170; 709/206

(57) ABSTRACT

A secure mail transmission system provides virus protection, document tracking, tamper proofing, authentication through digital signatures in addition to secure encryption means and time date verification for e-mail messages. The system encrypts a sent message at a user station and provides digital authentication and confidential encryption schemes prior to delivery of the secure mail message to the secure mail system over a communication network. The secure mail system unpacks the secure transmission, verifies the contents, provides a time date stamp and virus checking before reencrypting an retransmitting the original message. The transmission can be logged and stored for later verification. The recipient of the secure message can be a subscriber or non-subscriber and can use supported e-mail platforms, unsupported e-mail platforms, or unknown e-mail systems and receive the secured message with little or no variation from their typical application interface usage. The system provides secure features including the use of public/private key pairs, hashing algorithms and digital signatures to provide privacy and authentication of the secure mail messages. The private key associated with an individual user need not be stored anywhere. The system permits secure and private electronic communications with virus checking and return receipt notifications available.

This application is based upon and claims benefit of Provisional Application Ser. No. 60/206,580, filed on May 23, 2000, to which a claim of priority is hereby made.

### BACKGROUND OF THE INVENTION

1. Field of the Invention

The present invention relates generally to a system and method for delivering secure electronic mail across a communication network, and more specifically to a system and method for encrypting, digitally signing, virus-checking, time/date stamping, preserving privacy, and authenticating electronic mail delivered across a communication network independent of the sender's and recipient's electronic mail platforms.

2. Discussion of the Related Art

Electronic mail, or e-mail, has enjoyed vast popularity due to its simplicity, speed and cost effectiveness. In general, both commercial and private entities have made widespread use of e-mail as a communication tool to increase productivity and effectiveness. E-mail has become a fundamental communication tool, both for business and for personal use.

Perhaps because of the simplicity and speed of e-mail, users often fail to appreciate some of the drawbacks associated with sending information over an electronic network. For example, it is a simple matter to attach many different files of varying file types to an e-mail message for transmission to a number of recipients. If any of the transmitted files are infected with computer viruses, for example, it is possible for each recipient of the message to become infected with the virus.

Viruses spread rapidly if an infected message is forwarded to other recipients that become infected and then continue to propagate the virus by retransmitting or forwarding the infected message. This scenario illustrates how destructive viruses can be rapidly spread to a number of e-mail users. This danger in the widespread use of e-mail can actually be exacerbated by the design of some e-mail programs that provide a mechanism that permits a rogue e-mail to abuse access to an e-mail address list maintained within the e-mail platform. An e-mail message with destructive potential can access the e-mail address list maintained on a particular e-mail platform, and can cause itself to be sent to all addresses in the list. While virus checking software is available to ensure that the e-mail attachments are virus free, attachments in general are not affirmatively scanned as a matter of course.

Another drawback associated with e-mail communications is that they are relatively easy to intercept and view, which can compromise the security and confidentiality of e-mail messages. No tool is generally available to e-mail users to ensure that the e-mail message has not been intercepted. For example, sending an e-mail over a public network such as the Internet has been compared to sending a postcard through the postal mail, since the postcard content may be viewed at any time during its transmittal. In addition, it is possible to exploit a vulnerability in e-mail messages sent over a network that involves copying the e-mail message from one point to another. As the message is relayed between various points on the network, each relay point presents an opportunity for a copy of the e-mail message to be transmitted to a third party, or to the relaying system itself.

A partial solution to the difficulties discussed above involves using an encryption scheme to secure the content of the e-mail message. A typical encryption scheme is known as point to point encryption, which allows an e-mail sender to encrypt the e-mail message and send the encrypted message to one or more recipients, who can then unencrypt the message and view the contents. This type of point to point encryption typically relies upon a public key system in which the sender uses a public key to encrypt the e-mail message being sent, and the receiver can unencrypt the message using the recipient's private key paired with the sender's public key. One such well known public key system is typically referred to as pretty good privacy (PGP). Public key systems also offer the opportunity for digital signatures that can be used to verify document origin, in addition to providing tamper resistance for the transmitted document.

However, files secured by encryption offer no protection against viruses, for the simple reason that a file infected with a virus, once encrypted, will disguise the virus, which is also encrypted. In addition, available point to point encryption software is typically proprietary for each vendor. Accordingly, a sender and a receiver can only use point to point encryption if each uses the same encryption vendor's software. Unless the sender and receiver both subscribe to the same vendor encryption software, they cannot communicate securely. Moreover, even if an e-mail message is encrypted, an intercepting third party can still view the address and identity of both the sender and receiver, which remains unencrypted for transmission purposes.

In addition, it is possible that a sender or receiver using point to point encryption may have their system compromised, by having a portable computing device stolen, for example. A stolen device can provide an unauthorized third party with the private key of a user, permitting the third party to pose as a secure sender or receiver. Moreover, although an unlikely or rare occurrence, it is possible that a vendor may mistakenly distribute secure key pairs to third parties posing as a trusted content provider. Accordingly, the third party can pose as the content provider and fool persons accessing a web site, for example, into believing that the web site content is safe and from a trusted source.

Other schemes can potentially be used to fool a sender into believing an e-mail message is securely encrypted prior to transmission to the recipient, when in fact a third party is readily able to decode and read the message through a process known as spoofing. A spoofed e-mail message is one in which the sender is tricked into sending the encrypted message directly to a third party, who can then decode and read the message, and can then either (1) reencrypt the message to be read by the original intended recipient and forward the message, (2) modify the content of the message, reencrypt it and forward it to the original intended recipient, or (3) block the message altogether. Of course the interceptor can also forward the message to other parties for which the message was not intended to be received.

Another partial solution to the difficulty of securely transmitting e-mail is to use firewall based encryption and virus protection. According to this scenario, a firewall intercepts all incoming and outgoing e-mail messages and provides encryption-decryption service for each of the messages, in addition to scanning for viruses. However, the difficulties attendant with point to point encryption are also present with a security scheme involving a firewall. For example, the sender and recipient must use the same vendor public key encryption software. The correspondence activity between the sender and recipient can still be monitored with this scheme because the identity of the sender and receiver can be readily determined since they are not encrypted. In addition, since the encryption/decryption takes place at the firewall and typically not on the sender/recipient computer, the message must travel unencrypted between the sender/recipient computer and the firewall. In the course of this travel, the message is vulnerable to interception or inspection.

Another partial solution to the difficulty of securing e-mail communications is to provide a web based e-mail server. The sender of an e-mail using a web based e-mail server logs onto the server, typically using secure socket layer (SSL) communication link protection, and sends an e-mail message to one or more recipients. The e-mail message and any attachments are encrypted and can be checked for viruses. Each of the recipients of the e-mail message is then notified by regular unsecured e-mail messages. Each recipient upon receipt of the notification can log onto the web based e-mail server and read the message, which remains stored on the server itself.

The web based e-mail server scenario also has several drawbacks, including the fact that the sender and recipients all must learn a new interface to access the e-mail messages on the server. In addition, a web based e-mail server is typically less convenient to use, especially for a commercial entity that wishes to control and manage its own e-mail system, perhaps in conjunction with other associated activities such as calendaring, contact list maintenance and other types of group oriented electronic interchange. Furthermore, the web based e-mail server solution suffers from some of the same drawbacks as the other partial solutions described above, including vulnerability to third parties who can pose as recipients and obtain access to e-mail messages thought to be secure. In addition, when the sender uses the web based e-mail server to create a message to be sent to one or more recipients, the message arrives at the website in an unencrypted form. While the period of time between creation of the message and encryption is potentially short, the message is still vulnerable to interception and inspection. Websites are generally easy targets for persons or entities seeking to intercept messages or obtain information without authority, since websites are typically designed for easy access rather than for security. Security on a website is often more of an afterthought because the main intent and purpose of a website is to be open to the world.

Furthermore, since the web based e-mail server must notify all the recipients of a received e-mail, the e-mail communication is susceptible to activity tracking. For example, a third party wishing to know when the sender and recipients are communicating can monitor the notifications between the web based e-mail server and the recipients to obtain the identity of the parties communicating, and often the subject of the e-mail message.

Another partial solution to provide e-mail security involves a hybrid of the above described web based e-mail server. In this hybrid scenario, the sender logs on to a web server to obtain an encryption key. The sender then encrypts an e-mail message on their local terminal, and sends the e-mail message to the recipient, who must then access the web server to obtain the decryption key for the message. As with other partial solutions mentioned above, the hybrid solution also suffers from the drawback that a third party can potentially pose as the e-mail server and intercept communications for which the third party has the encryption/decryption keys. In addition, this hybrid method can not offer virus checking features. As with the standard web based e-mail server model discussed above, this hybrid solution is also susceptible to activity monitoring, because the actual e-mail itself, even though encrypted, is sent directly from sender to recipient. Moreover, the user of the hybrid system must become familiar with yet another application interface, which can lead to frustration and lack of productivity on the part of the user.

Accordingly, there is need for a secure system with a familiar user interface for transferring e-mail messages that also provides virus checking and a high level of privacy.

### SUMMARY OF THE INVENTION

It is an object of the present invention to overcome the drawbacks of the prior art discussed above.

Briefly stated, there is provided according to the present invention a client-server system for sending and receiving secure e-mail transmissions that are date stamped, virus scanned and authenticated at a centralized server. The client application runs as an add-on or feature of the client e-mail system. The server acknowledges sent e-mail, and can provide a secure copy of the message and a return receipt to the sender. The sending and receiving parties are verified from a central database to aid in prevention of tampering. The e-mail message is given a digital signature for authentication upon being sent, and the server adds another digital signature, in addition to encrypting the message with a different key than that used by the sender before re-transmitting the secure message to the recipients. The sending and receiving parties of the e-mail message are not both exposed at the same time, thereby preventing activity monitoring. The recipients can receive, unencrypt, and read the secure e-mail message without fear of loss of privacy or infection by viruses. The digital signature provides a non-repudiation mechanism for verifying sending and receiving party intentions. The present invention satisfies a primary criteria for secure document transmission of confidentially, integrity, accountability, and ease of use.

According to an embodiment of the present invention, there is provided a sending station, a verification station and a receiving station. The sending station produces a hash code from a hashing operation on an electronic message, encrypts the message with a random encryption key and generates a digital signature from the hash code and a sender private key from a sender public/private key pair. The encrypted message, the random encryption key, the digital signature, the sender public key from the sender public/private key pair and a public key from the verification station are all transmitted in a package to the verification station. The verification station performs the reverse operations to obtain the original message, verifies the content with the hashing operation in comparison with the digital signature, time and date stamps the message and scans it for viruses. Once the message is verified, a new digital signature is generated as described above, and the message is encrypted with a new random encryption key and sent to the receiving station. The secure communication to the receiving station includes the digital signature, the encrypted message, the encrypted random encryption key, the receiving station public key (if available) and the verification station public key. A reverse process is undertaken at the receiving station to unpack and view the message.

### BRIEF DESCRIPTION OF THE DRAWINGS

FIG. 1 is a diagram showing an overview according to the present invention;

FIG. 2 is a diagram of interconnectivity of components of the system according to the present invention;

FIG. 3 is a diagram of the end to end flow according to the present invention;

FIG. 4 is an example of mail center message flow according to the present invention;

FIG. 5 is a diagram showing load distribution and reciprocal backup according to the present invention;

FIG. 6 is a description of the sender message packaging according to the present invention;

FIG. 7 is a diagram showing an overview of the secure e-mail server according to the present invention;

FIG. 8 is a diagram showing unpacking and checking of the sender message at the server according to the present invention;

FIG. 9 is a diagram showing repackaging of the message at the server for transmission to the recipient(s) according to the present invention;

FIG. 10 is a diagram showing treatment of messages transmitted to recipients having various e-mail platforms according to the present invention;

FIG. 11 is a diagram showing treatment of a secure message received by a subscriber in a supported e-mail environment according to the present invention;

FIG. 12 is a diagram showing a secure message received by a subscriber using a generic e-mail environment;

FIG. 13 is a diagram showing a secure message received by a non-subscriber as a secure generic form e-mail message according to the present invention;

FIGS. 14A, B, and C show diagrams of support routines for obtaining public keys, verifying identities and status, respectively, according to the present invention;

FIG. 15 is a diagram of a menu table describing installation options according to the present invention; and

FIG. 16 is a diagram of sender options shown in a menu table according to the present invention.

### DETAILED DESCRIPTION OF THE PREFERRED EMBODIMENTS

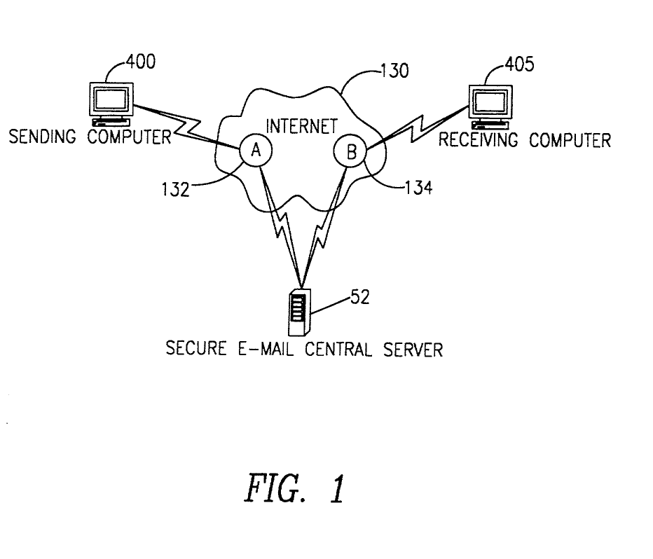

Referring now to FIG. 1, an overview of the system according to the present invention is shown. A sending computer 400 is connected to a communication network 130, such as the Internet, over a communication link. A network node 132 handles packet switched communication between sending computer 400 and a central server 52. Central server 52 is also connected to node 132 of communication network 130. Node 132 is an abstract node, in the sense that it may be comprised of a number of nodes and interconnected computers comprising the communication network. Central server 52 is also connected to another node 134 of the communication network 130. A receiving computer 405 is also in connection with node 134 of communication network 130. The overview of FIG. 1 shows how e-mail messages can be sent by sending computer 400, through central server 52 and received by receiving computer 405 through connections to node 132, 134 of communication network 130.

The system according to the present invention shown in FIG. 1 permits secure e-mails to be sent from sending computer 400 and received in receiving computer 405. Central server 52 provides secure authentication, virus checking, time and date stamping as well as flexibility with regard to the type of system used by the message sender and recipient. The system operates by encrypting an e-mail message at sending computer 400 and sending the encrypted message to central server 52 through communication network 130. The encrypted e-mail message is unpacked, verified and virus checked, before being repackaged for transmission to receiving computer 405. Once the e-mail message is repackaged in a secure format, it is transmitted through communication network 130 via node 134 to receiving computer 405. The recipient is notified of the encrypted e-mail and, according to one embodiment of the present invention, is provided with instructions on opening and unencrypting the e-mail message, if necessary. The system operates with a number of different hardware and software platforms by which receiving computer 405 sends and receives e-mail messages.

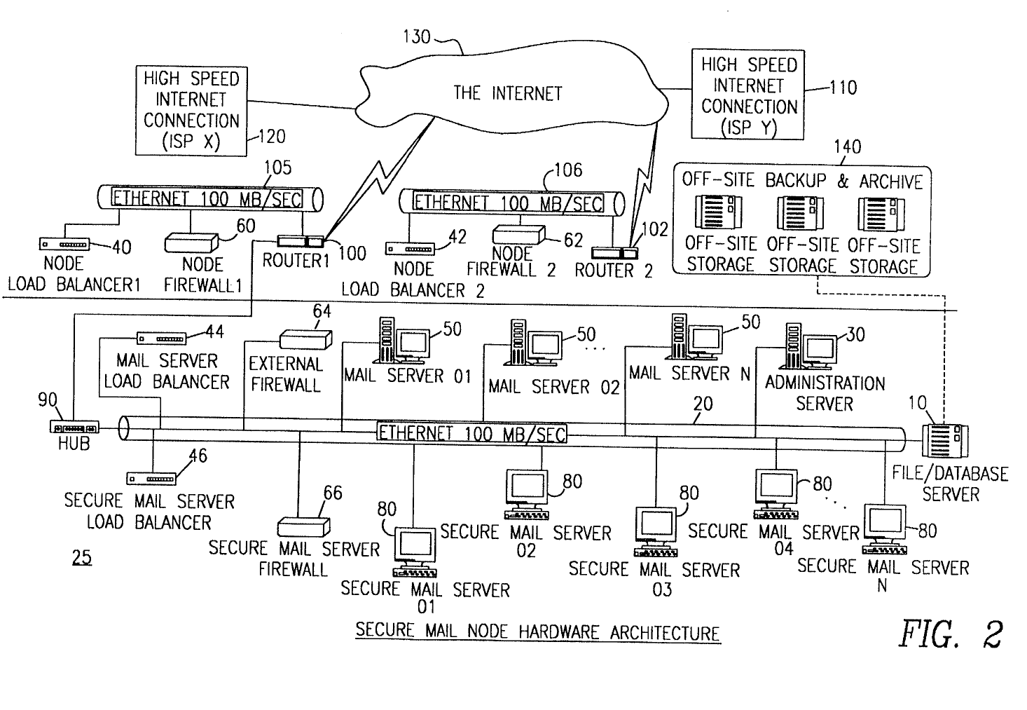

Referring now to FIG. 2, central server 52 as illustrated in FIG. 1 is explained in greater detail. As shown in FIG. 2, central server 52 is comprised of a number of workstations and servers connected and operating through a local area network (LAN) 20. LAN 20 has connected to it a file/database server 10 that provides network services such as printing, file sharing and access to an off-site backup and storage system 140.

LAN 20 is connected through a hub 90 to external LAN 105. External LANs 105 and 106 are connected to communications network 130 and provide load balancing, fire wall protection and routing for communication with communication network 130 and a node 25 comprising LAN 20. LAN 105 includes a load balancer 40, a fire wall 60 and a router 100. Similarly, LAN 106 includes a load balancer 42, a fire wall 62 and a router 102. Load balancers 40 and 42 examine communication traffic from communication network 130 and determine how best to divide resources available to handle the communication traffic. Fire wall 60 protects LAN 20 from unauthorized access through communication network 130. Fire walls 60 and 62 are designed to protect against unauthorized accesses such as can occur when communication network 130 is used to attack or infiltrate LAN 20, for example, or when undesirable content is attempted to be transferred from communication network 130 to LAN 20. Router 100 switches communication traffic between communication network 130 and LAN 20 under the direction and control of load balancer 40 and fire wall 60.

It is preferable that LAN 20 operate at a 100 megabits per second or faster. LAN 20 is set up and maintained by an administration server 30 that has access to the equipment attached to LAN 20. For example, administration server 30 can be operated to set up mail servers 50, secure mail servers 80, as well as load balancers 44 and 46, and fire walls 64 and 66 that are attached to LAN 20. Administration server 30 can be used to adjust settings in each of the network components, for example, specifying network addresses of communication network 130 that will not be accepted past fire walls 64 or 66. Administration server 30 can also be used to configure LAN 20 to recognize Internet service provider connections 110 and 120 that are authorized to connect to LAN 20 through communication network 130. For instance, a user that has been provided with authorized access to LAN 20 may wish to access LAN 20 through communication network 130 on a remote basis. Accordingly, administration server 30 can provide settings to enable the remote user to connect to LAN 20 from Internet service providers 110 and 120 via communication network 130.

Load balancers 44 and 46 provide balancing services to LAN 20 for mail servers 50 and secure mail servers 80, respectively. Through the use of load balancers 44 and 46, each set of respective resources can be used with greater efficiency than if load balancers 44 and 46 were not present. For example, communication jobs directed to any of the various mail servers 50 can be distributed among various mail servers 50 according to the size of a job or resources available to particular mail servers 50. Similarly, secure e-mail communication jobs can be distributed across the various secure mail servers 80 to improve the efficiency of communication handling and maximize utilization of available resources. When load balancers 40, 44 and 46 are configured to work in concert, for example, overall efficiency of node 25 can be improved.

Fire walls 64 and 66 provide an extra level of protection in addition to fire wall 60, which is external to LAN 20. For example, fire wall 64 adds protection to accesses made to mail servers 50 to prevent unauthorized or unwanted access or messages. Fire wall 66 provides a similar function for secure mail servers 80.

It should be apparent that the configuration of node 25 is just one embodiment of a hardware configuration according to the present invention. Any number of node configurations are possible, provided a computer can be connected to a communication network such as communication network 130 to process electronic mail and provide security functions such as authentication, virus scanning and encryption or unencryption. In addition, access to node 25 can be provided on a wireless basis, such as is available with mobile phones and other wireless personal digital assistants (PDAs). Furthermore, the communication network exemplified by communication network 130 can be any type of communication network, including public, private, local, wide area and worldwide. The communication methods used by communication network 130 are not limited according to the present invention. That is, communication network 130 can take advantage of any technology for communication, including analog, digital, cable and wireless communication. It should be noted that backup, archival and storage functions provided by backup and storage system 140 can be any type of secure backup and archive storage system that can obtain and preserve data from LAN 20 through server 10 for retrieval at a later point in time. Backup and storage system 140 can be local, off site, network connected, or a manual media storage vault, for example.

Node 25 shown in FIG. 2 comprising LAN 20 and the attached components, can be replicated any number of times. For example, any number of nodes comprising a LAN 20 and attached components can be connected to each other directly, or through communication network 130. Accordingly, various nodes can be distributed across a wide area or locally, and can function as a single network on an enterprise basis, for example.

Node 25 processes secure e-mail messages that are sent and received through LAN 20, hub 90, router 100 and communication network 130. Secure e-mail messages are processed by secure mail servers 80 and provided to the appropriate party. For example, a sender or receiver may be located at node 25 and connected to LAN 20. Such a sender or receiver would have direct access to the secure mail services provided by secure mail servers 80. Alternatively, a secure e-mail user may be located remotely from node 25 and connected to node 25 through communication network 130.

In the case where the secure e-mail user is directly connected to LAN 20, the user workstation need not have secure e-mail software resident on their local PC. Instead, such a directly connected user can send and receive e-mails through LAN 20, with the security, authentication and virus checking features being transparent to the user. An e-mail message sent by a user directly connected to LAN 20 is processed by secure mail server 80 to provide encryption, authentication and virus checking services. Secure mail server 80 processes the e-mail messages and packages the messages for transmission through communication network 130 to the intended recipients. The recipients of the packaged, secure e-mails can access the enclosed message in a number of flexible formats as discussed more fully below.

A user need not be directly connected to LAN 20 to send secure e-mail messages using secure mail server 80. For example, if a user is located at a remote site, it is still possible for the user to connect to node 25 across communication network 130. The remote user is typically given remote access authorization to remotely access node 25 and secure mail servers 80. Secure mail servers 80 are again used to process and repackage the e-mail message to provide authentication, encryption and virus checking services. In this embodiment, however, the remotely located user has secure mail software resident on their (typically) portable personal computer. The resident secure mail software permits the e-mail messages sent by the remote user to be encrypted, digitally signed and packaged for transmission to node 25. At node 25, the e-mail message is unpacked, unencrypted, authenticated, virus checked and time and date stamped by secure mail servers 80, prior to being retransmitted to the intended recipient(s). Once the secure e-mail message has been verified, it is repackaged with another digital signature, encrypted and ready to be retransmitted to the intended recipient(s).

Each transmission between node 25 and communication network 130 passes through fire walls 64 and 66, and is routed according to balancing schemes determined by load balancers 44 and 46. Node 25 further has an overall fire wall 60 attached through LAN 105 to router 100 to provide further protection for node 25 against unauthorized access through communication network 130. Node 25 further is provided with load balancing services for all e-mail messages being sent and received through load balancer 40.

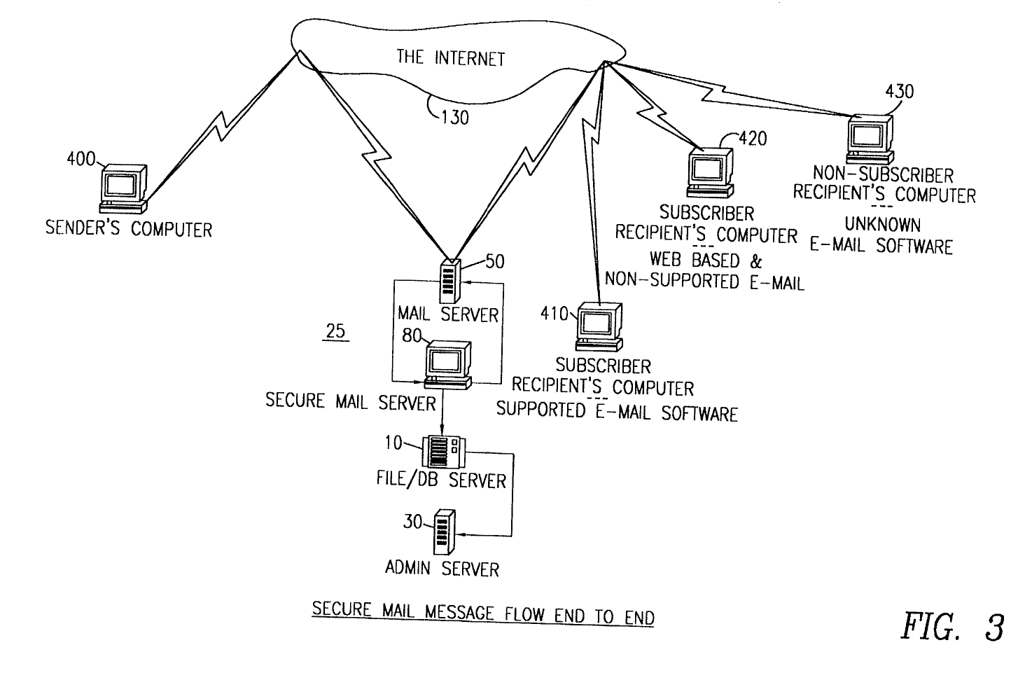

Referring now to FIG. 3, a diagram of the flow of a typical secure e-mail message is shown. Sender computer 400 is used to composed an e-mail message, including any type of electronic file in the message body or as an attachment. The system according to the present invention supports a number of well known e-mail systems, any of which may be used to compose the e-mail message on sender computer 400.

Once the sending user has completed the e-mail message to be sent, and selects a send function, software instructions stored in sending computer 400 execute to transform the complete e-mail message into a form according to the system of the present invention. When transformed into a form according to the system of the present invention, the sender private key is obtained to encrypt the message. The reformatted message is “hashed” according to an algorithm that provides a result that is highly unique with regard to the contents of the reformatted e-mail message. The resulting digital hash code is used in combination with the sender private key to produce a digital signature for the sender's message. The sender public key is then added to the reformatted message, and both are encrypted with a one time random symmetrical key. The one time random symmetrical key is then further encrypted with the secure mail system public key. The encrypted public key is packaged with the encrypted and reformatted message, the digital signature, the sender's encrypted public key and the secure mail system public key, all of which is sent as an attachment to secure mail server 80 through communication network 130.

According to a preferred embodiment of the present invention, the sender's private key is not stored anywhere, but is rather generated whenever needed. An authentication password or pass phrase can be used as the seed for execution of an algorithm that generates a public/private key pair each time the password or pass phrase is entered into the system. Preferably, the public/private key pair only exists in volatile memory for a short period of time and is removed after being used for encrypting or decrypting a message.

Another alternative to generating a public/private key pair from a password or pass phrase is to provide a unique indicator of the sender or receiver identity through a device, and use the unique indicator to validate messages. For example, a device capable of providing a unique code is attached to a computer port and accessed each time a message is signed for transmission, or authenticated upon receipt. If the device is missing, or provides an improper code, the sender or receiver may not open the transmitted or received document, respectively.

Devices known as “smart cards,” which require possession of the device and entry of an identifying code to authenticate identity, can also be used to verify a message. The smart card produces a code that can be used as the seed for execution of an algorithm to generate the public/private key pair used in the encryption of a sent or received message. This result can also be achieved through the use of biometric confirmation devices, such as fingerprint readers, retinal scanners and hand-geometry readers, for example. A unique code generated by these types of identity confirmation devices can be used as the basis for generation of public/private key pairs to be used in authenticating messages, without ever having to store a private key.

Once the packaged e-mail is sent by the sending party, it is received by mail server 50 through communication network 130, and is virus scanned to ensure that no viruses were attached to the e-mail during transmission. The scanned e-mail is then sent to secure mail server 80 for processing. The system load on available resources in node 25 of FIG. 3 is balanced as new messages are sent and received through mail server 50.

Once a secure e-mail is received by secure mail server 80, the message is time and date stamped. Time and date stamping provides the message with an indication of the time and date received by secure mail server 80. Time and date functions with regard to stamping are assisted and processed by synchronization with, for example, atomic clocks providing synchronization signals through satellite communications.

After time and date stamping, the secure e-mail message is unpacked and verified for any changes during transmission or viruses in the message itself. Once verified, the message is given a new digital signature by secure mail server 80, is repackaged and sent to the recipient(s). The reformatted message may at this point be stored along with the digital signature for a later verification, according to user options selected for the transmission of e-mail messages. In addition, accounting and transaction data is logged and recorded for use by file/database server 10 to keep track of customer or subscriber usage and generate information relating to accounting and billing.

Administration server 30 is used to manage the storage of messages in file/database 10 and also has access to accounting and billing information stored on file/database 10. Administration server 30 generates accounting reports, billing statements and completes credit and debit transactions related to services used by subscribers and users. For example, the administration server 30 can be used to charge credit cards or accounts for services that are used, as well as transfer funds between vendors and customers, for instance.

Once the verified e-mail message is digitally signed by secure mail server 80 and repackaged, it is re-sent to the recipient through communication network 130. Examples of various types of recipients are shown in FIG. 3 as subscriber recipient 410, 420 and non-subscriber recipient 430. Subscriber recipient 410 is an example of a recipient of a secure e-mail using a “supported” e-mail software package. For example, as mentioned above, a secure mail system according to the present invention supports several popular e-mail software and hardware platforms. This support feature potentially provides the sender and recipient with increased functionality for transferring e-mail messages.

For example, if sender computer 400 and subscriber recipient 410 both use the same, widely implemented software for calendaring of tasks and appointments, subscriber recipient 410 can immediately interpret a task or appointment sent by sender computer 400, and the task or appointment can immediately be incorporated into a calendar for subscriber recipient 410. According to this scenario, the reformatted e-mail message transformed from the sender's original message is readily interpreted in its original form and structure as provided by the sender when composing the original message. Subscriber recipient 410 is thus notified that a received e-mail is pending according to the format of the supported e-mail software. The e-mail, upon selection by the recipient, is decrypted with the recipient's private key and unpacked to become a normal message understood by the supported e-mail software used by subscriber recipient 410, all of which is transparent to the user.

Subscriber recipient 420 is notified of pending e-mails in the same way as subscriber recipient 410. However, subscriber recipient 420 employs a web based or other non-supported e-mail system. In this scenario, the received e-mail message is received as an attachment that is opened by the user. The attachment is decrypted with the recipient private key and opened as a reformatted form message providing the contents of the sender's message in generic form. A publicly available tool or interface can be used by subscriber recipient 420 to access and view the contents of the secure e-mail system, for example.

Non-subscriber recipient 430 is similarly notified of receipt of an e-mail, as with subscriber recipient 410 and 420. However, the e-mail system used by non-subscriber recipient 430 is a format unknown to the secure mail system. Accordingly, when an attempt is made by the user at non-subscriber recipient 430 to open the secure e-mail, the user is prompted for an authorized password that has been conveyed by the sender separately through, for example, other communication means. Non-subscriber recipient 430 enters the password as requested, which is then used to generate a private key suitable for unencrypting the secure mail message. Once unencrypted, non-subscriber recipient 430 can access and view the contents of the secure e-mail message in a reformatted, generic form.

It should be noted that subscriber recipient 410, 420 and non-subscriber 430 all receive a secure, time and date stamped, digitally signed and authenticated, plus virus checked e-mail message. Subscribing users that can take advantage of supported e-mail interfaces can send and receive secured e-mail messages through a transparent overlay to their normal user interface. Subscribing users that employ web based or other non-supported e-mail systems receive simple generic form e-mail messages, containing all the content provided by the message sender, in a secured and easily accessed format. Non-subscriber users receive a simple executable attachment that can be viewed in a simple generic format, once accessed with a password or pass phrase.

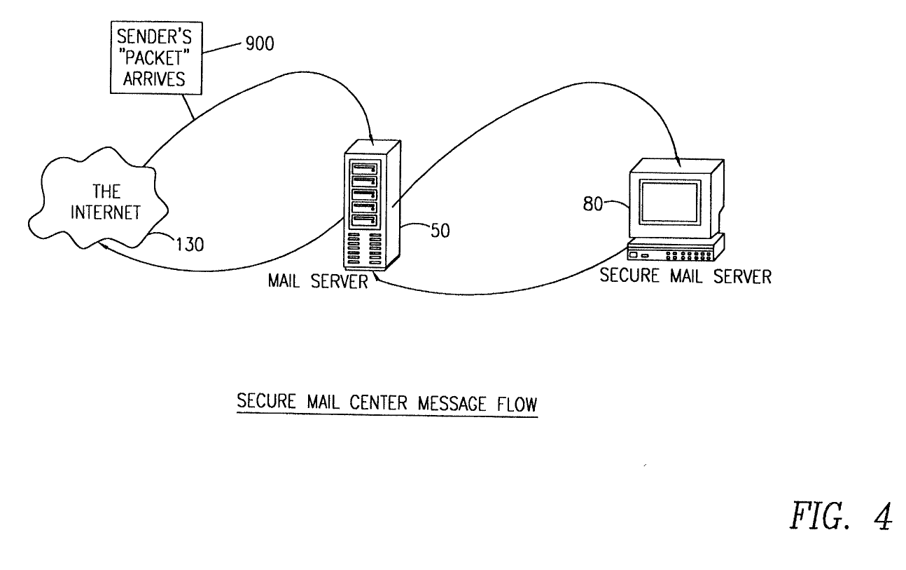

Referring now to FIG. 4, a diagram of message flow through secure mail server 80 is illustrated. A secure mail message according to the present invention is sent through communication network 130 as a packet 900. Packet 900 is received by mail server 50 from communication network 130 and is scanned for viruses before being transferred to secure mail server 80 through a load balancing process.

Once received at the processing secure mail server 80, the secure mail message is unpackaged and the one time random symmetrical key is decrypted with a public key known to secure mail server 80. The one time random symmetrical key is used to unencrypt the sender's public key and the generic reformatted message, together with the digital hash code representative of the generic reformatted message. The sender's public key is used together with the regenerated digital hash code to verify the digital signature and lack of tampering. The unencrypted e-mail is virus scanned and a date and time stamp is provided to further authenticate the message. The unencrypted message itself is not stored on any system susceptible to backup or archival methods, unless so designated by the user. Secure mail server 80 updates a log file, if the option is selected by the user, to record receipt and status of the secure e-mail message.

If the received e-mail message is properly authenticated and passes all other security checks, it is again digitally signed by secure mail server 80. The digitally signed message is then encrypted with either a recipient's public key, if available, or a password generated public key, or encryption using a third party secure e-mail system. The reincrypted message is mailed from secure mail server 80 to the recipient through mail server 50 and communication network 130. If the option is selected, the mail message can be stored with the encryption key, and a log can be updated regarding transmission of the e-mail message. At the same time, information related to accounting is accumulated and stored for use in tracking and billing account information for the e-mail message transaction.

The system according to the present invention permits the selection of various options for handling e-mail messages based on an assigned message status. For example, the sending user can select notification of receipt of the secure e-mail message, or notification if the message is determined to contain a virus. Alternately, the e-mail sender can select to send the e-mail message even after being apprised of its virus content. Options for transmission of secure e-mail are discussed in further detail below.

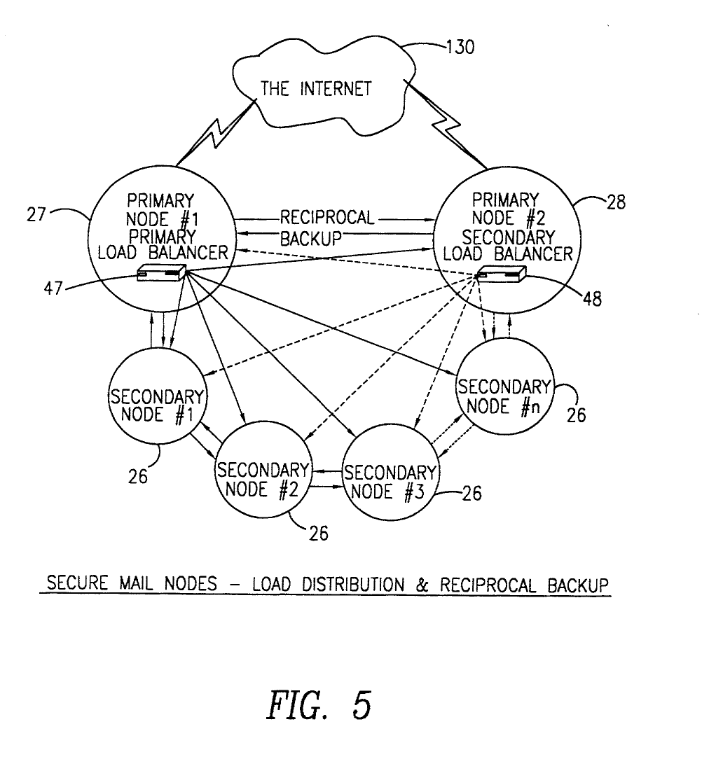

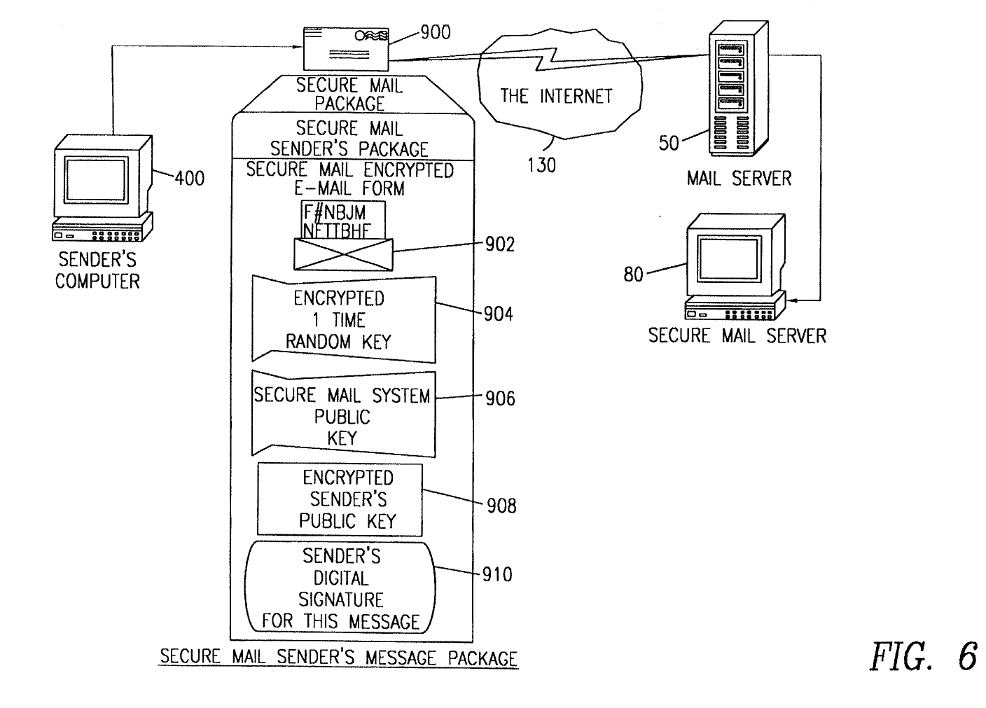

Referring now to FIG. 5, a diagram illustrating load balancing on various nodes is provided. Primary nodes 27 and 28 are coupled to communication network 130 and can send and receive electronic messages through the respective connections. Primary node 27 receives and processes all e-mail transmitted from communication network 130. Primary node 27 acts as a distribution center for balancing and distributing the load of received e-mail for processing among the primary and secondary nodes. Primary node 27 is coupled through load balancer 47 to primary node 28 and secondary node 26. If one of the primary nodes 28 or secondary nodes 26 become inoperable, load balancer 47 prevents distribution of e-mail to the inoperable node. If primary node 27 or load balancer 47 become inoperable, primary node 28 begins receiving all e-mail from communication network 130, and distributes the e-mail to all other nodes in an even distribution or load balancing process. That is, primary node 28 takes over the role of primary node 27 in balancing the load of processed e-mail, and load balancer 48 takes over the role of load balancer 47 in distributing e-mail for processing among the various nodes. As with primary node 27, if one of the nodes becomes inoperable, primary node 28 prevents e-mail messages from being sent to the inoperable node until the node again becomes operable.

This configuration of nodes handling e-mail loads in a balanced manner is also particularly useful for reciprocal backup. Each node, whether primary or secondary, is connected to two adjacent nodes. Accordingly, each node serves as a backup node for data stored at two other nodes, and is itself backed up by two other nodes to which it is coupled. If a node in this configuration becomes inoperable, its data files are still available at two other physical locations containing reciprocal backups of the inoperable node. The two nodes adjacent to the inoperable node have reciprocal backups coupled to them, so that backup information is still available even while the one node serving as a reciprocal backup is inoperable. With this distribution and load balancing configuration, a large volume of e-mail messages of widely varyings size and description can be handled efficiently by appropriate use of available resources through load balancing and reciprocal backup.

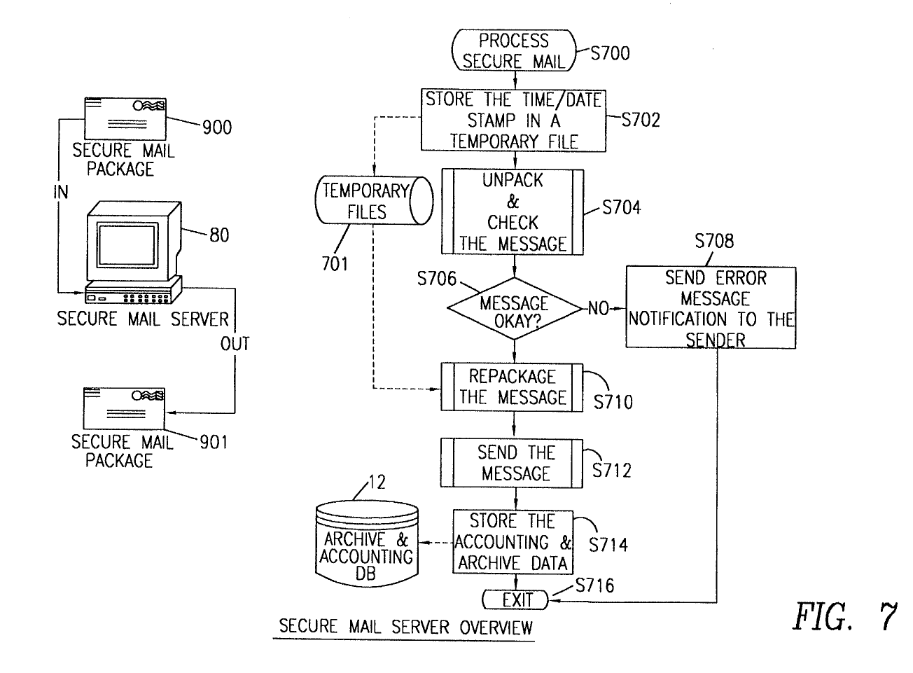

Referring now to FIG. 6, a diagram of the sender's e-mail message packaging and transmission is shown. The sending user first composes an e-mail message on sending computer 400, using an e-mail application familiar to the sender. If the e-mail application used by the sender is supported by the secure mail system according to the present invention, the e-mail package for secure e-mail transmission is assembled automatically by selecting the secure mail option provided as an add-on to the supported e-mail software. If the sender is using an e-mail system that is not supported by the secure mail system according to the present invention, a secure mail package is again automatically assembled, however, the package must be manually inserted as an attachment to an e-mail in the system used by the sending user.

The assembled package includes the sender's e-mail as transformed by the system according to the present invention. The transformed message includes text messages and headers, attachments and optional recipient requests. The reformatted message is encrypted with a one time random symmetrical key to produce encrypted message form 902. A public key 906 associated with the secure mail system according to the present invention is then used to encrypt the one time random key and a sender's public key to produce an encrypted one time random key 904 and an encrypted sender public key 908. Encrypted sender public key 908 is the key used to verify the sender's digital signature once received at secure mail server 80.

Prior to an encryption of the reformatted message, a complex hash algorithm is used to generate a digital hash code from the reformatted message contents. The digital hash code can be used to verify the uniqueness of the reformatted message as an anti-tamper verification. The digital hash code is combined with the sender's private key (not shown) to produce a highly unique sender digital signature 910. Sender digital signature 910 is used to authenticate the message and to verify that the message has not been tampered with.

Reformatted encrypted message 902, encrypted one time random key 904, secure mail system public key 906, encrypted sender's public key 908 and sender digital signature 910 are all packaged together to form the assembly of the secure e-mail message that is transmitted to secure mail server 80. Once the contents of the secure mail package are combined, the entire package is transmitted over communication network 130 to mail server 50 located within a secure mail server node, such as node 25 shown in FIG. 2.

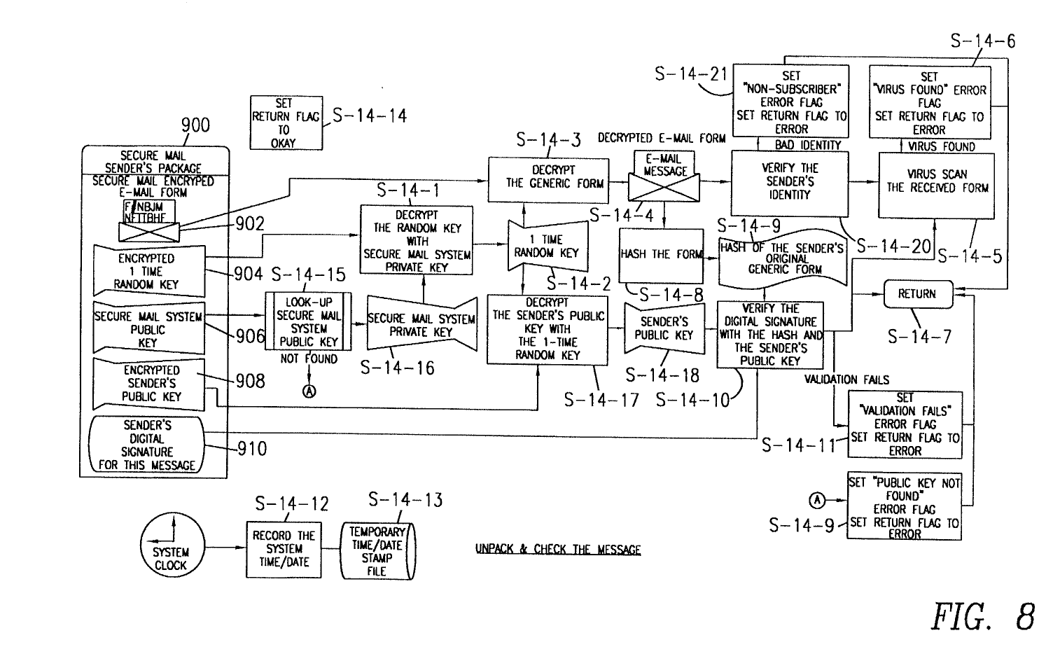

Referring now to FIG. 7, a received secure e-mail package 900 is processed by secure mail server 80 to produce a recipient secure mail package 901. The operation of secure mail server 80 is shown in FIG. 7 beginning with step S700, in which secure mail package 900 is received. Received secure mail package 900 is time and date stamped upon receipt by secure mail server 80 and the time and date stamp is stored in temporary files 701 in step S702. The message contents are unpacked and checked in a verification process in step S704. Checking the message ensures a valid, tamper-free transmission of the secure message.

Public key 906 is matched with an associated mail system private key that is retrieved for use in unencrypting the message. Encrypted one time random key 904 is then decrypted using the secure mail system private key, which in turn is used to unencrypt encrypted sender public key 908. The message form is then decrypted using the one time random key, and the header information containing transmission information is saved.

Now that the message form is in unencrypted format, it is virus checked and operated on by a hashing algorithm to produce a digital hash code. The digital hash code is combined with the sender's unencrypted public key to verify digital signature 910 included in the message.

If the secure mail message passes all the verifications, as illustrated in decision step S706, the message is repackaged in step S710. If any of the verifications fail when the secure mail message is checked, decision step S706 branches to step S708 in which secure mail server 80 generates an error message for notification to the sender that there was a problem with the sent message.

The verified message is combined with the saved time and date stamp information saved in temporary files 701, along with other indicia added by secure mail server 80 to produce a new, expanded, verified message form. The verified message form is operated on by a hashing algorithm to produce another digital hash code. The new digital hash code is then used with the secure mail server private key (obtained as the private key portion of the secure mail server public/private key pair matched with secure mail server public key 906) to produce a mail server digital signature unique to the new, expanded, verified message form. Another one time random key is generated and used to encrypt both the new, expanded, verified message form, and secure mail server public key 906.

All the components of the message are repackaged and assembled for transmission in step S710, and can alternately be stored in secure mail server 80, or an attached storage system, according to transmission options chosen by the sender. The message is retransmitted in step S712, while accounting and archive data is stored on file/database server 10 in step S714. While a particular archive and accounting database 12 is shown in FIG. 7, it should be apparent that any number of databases or storage locations can be used in accomplishing step S714. The processing of the secure mail message 900 completes in step S716, having sent secure mail package 901 in step S712.

When the message is repackaged in step S710, several repackaging options are available, depending on the recipient e-mail system. For example, if the recipient is a subscriber to the secure mail system, then the one time random key is encrypted with the recipient public key, as registered with the secure mail system according to the present invention. Once the one time random key is encrypted and packaged with the encrypted form, the encrypted secure mail system public key, the recipient public key and both digital signatures, the package is attached to an e-mail message and the original subject from secure mail package 900, that is stored in temporary file 701, is used to provide the subject field, and the e-mail is sent to the recipient, as in step S712.

If the recipient is not a secure mail system subscriber, the random symmetrical one time key is encrypted with a public key that is generated from a password, or pass phrase, packaged with the encrypted form, the encrypted secure mail system public key, the password, or pass phrase, generated public key and both digital signatures, and the package is sent as an attachment in an e-mail, in which again the original subject of secure mail package 900 is provided for the subject line in the retransmitted e-mail, in addition to the sender address. Again, the verified secure mail package 901 is sent in step S712.

Referring now to FIG. 8, a diagrammatic chart showing the process of unpacking and checking secure mail package 900 is shown. Secure mail package 900 is received at secure mail server 80, at which point a system time and date is accessed for use with time and date verification stamping. Secure mail system public key 906 is extracted from secure mail package 900 and used in process S-14-15 to look up a public/private key pair in a data base maintained in secure mail server 80. In step S-14-14 a return flag is initialized to show successful verification. If secure mail system public key 906 is not found in the public/private key pair data base, connector A is selected, leading to step S-14-19. In step S-14-19 the return flag is set to indicate an error, caused by the lack of an entry for the transmitted secure mail system public key 906.

If secure mail system public key 906 is found in the public/private key pair data base, a secure mail system private key is returned in step S-14-16. The secure mail system private key is used to decrypt encrypted one time random key 904 in step S-14-1 to produce the unencrypted one time random key in step S-14-2.

The unencrypted one time random key is used to decrypt both the reformatted message in step S-14-3 and encrypted sender's public key 908 in step S-14-17. The reformatted message decrypted with the one time random key results in the decrypted reformatted mail message in step S-14-4. The decrypted reformatted mail message is used to verify the sender's identity in step S-14-20, with an improper identity, or non-subscriber, being enunciated by an error code in the return flag as set in step S-14-21. If the sender's identity is verified as proper, and as a subscriber, in step S-14-20, then the decrypted reformatted mail message is virus scanned in step S-14-5. If a virus is found, the return flag is set to indicate an error in step S-14-6. Otherwise, if no virus is found, the process proceeds to return step S-14-7.

The decrypted reformatted mail message is also operated on by a hashing algorithm in step S-14-8, the result of which is compared to the digital hash code of the sender's original reformatted mail message, in step S-14-9. The digital hash code and sender's public key obtained after decryption with the one time random key in step S-14-17 and S-14-18 are combined to verify sender digital signature 910 provided with original secure mail package 900, in step S-14-10. If a digital signature is verified properly, the verification and checking process has completed successfully and returns in step S-14-7. If the validation of the digital signature fails, the validation error flag is set in step S-14-11, and the return flag is set to indicate that an error has occurred.

According to the process of unpacking and checking the message, the only path that allows a return in step S-14-7 without an error being set in the return flag is if the e-mail has been properly validated, and contains no virus after the virus scan. All other paths leading to the return in step S-14-7 will return an error indicating a problem with secure mail package 900.

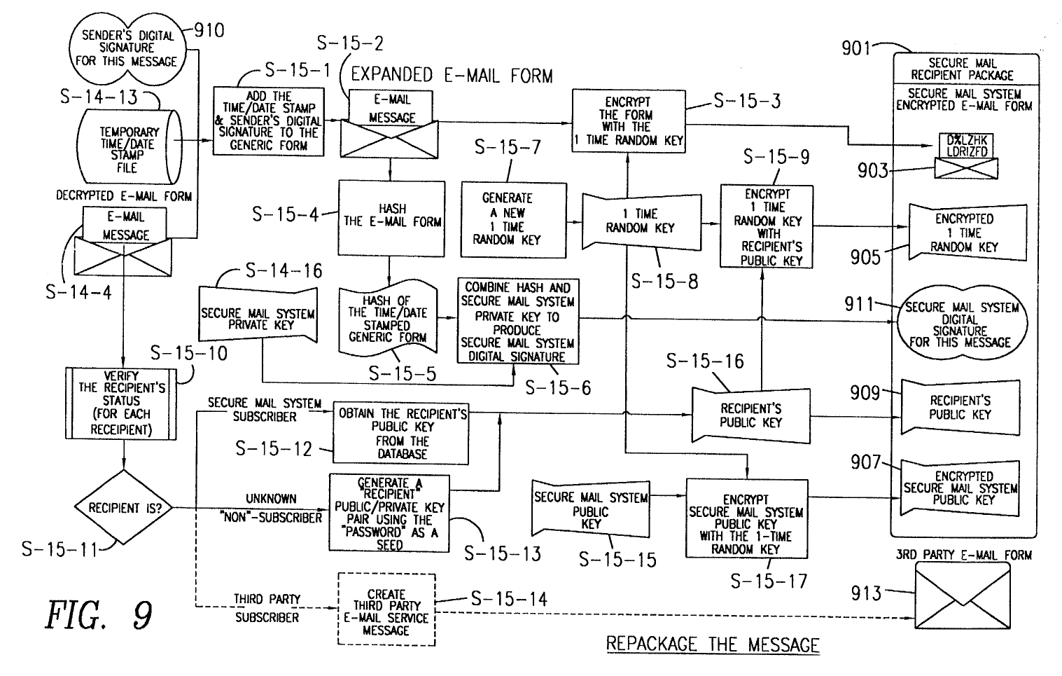

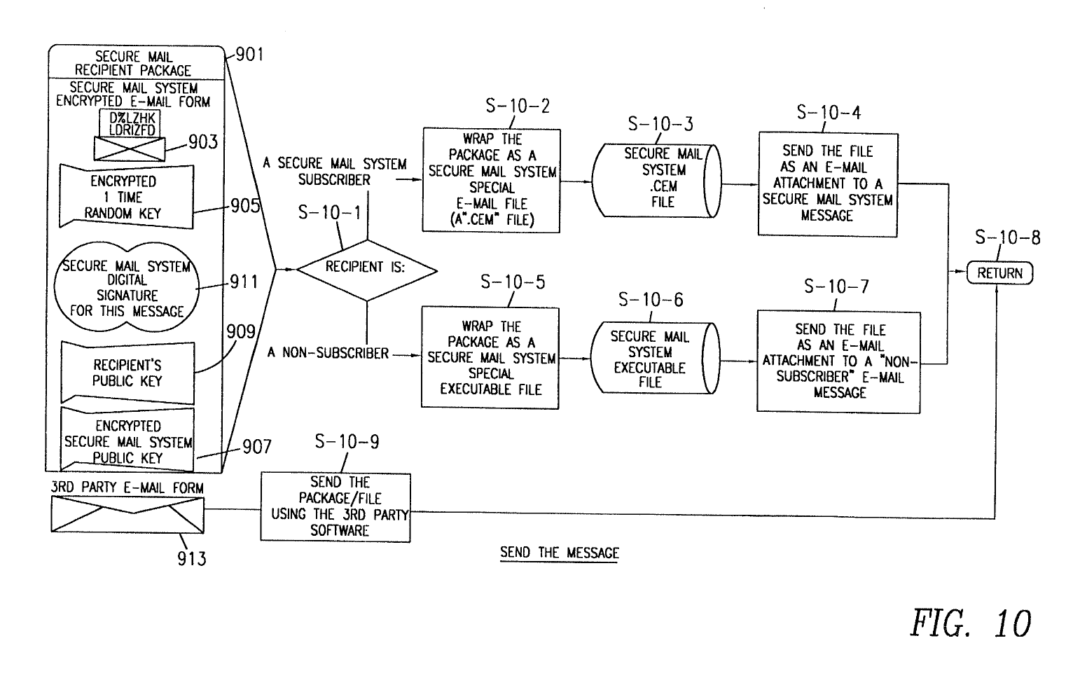

Referring now to FIG. 9, a diagram showing the repackaging of the secure e-mail message according to the recipient e-mail system is shown. Repackaging of the secure message for transmission to the intended recipient begins with providing sender's digital signature 910, the temporary time/date stamp file provided in step S-14-13, and the deencrypted reformatted mail message from step S-14-4, as shown in FIG. 8. These three items are combined together as shown in step S-15-1 in FIG. 9 to produce an expanded reformatted mail message in step S-15-2. A hashing algorithm is applied to the expanded reformatted mail message in step S-15-4, to provide the digital hash code for the expanded reformatted mail message in step S-15-5. A secure mail system private key is obtained in step S-14-16, and combined with the digital hash code to produce a new secure mail system digital signature 911 in step S-15-6. An algorithm is executed in step S-15-7 to generate a new random symmetrical one time key, shown in step S-15-8, that is used to encrypt the expanded reformatted mail message in step S-15-3. The random symmetrical one time key shown in step S-15-8 is also used in step S-15-17 to encrypt the secure mail system public key shown in step S-15-15. An encrypted secure mail system public key 907 results from the encryption of the secure mail system public key with the random symmetrical one time key.

The repackaging operation differentiates the recipient e-mail systems to then provide further encryption functionality. In step S-15-10, each recipient listed in the sender's e-mail message is provided with a status according to their e-mail system. According to different statuses determined in decision S-15-11, the recipient can be a secure mail system subscriber, an unknown non-subscriber, or a subscriber to a third party e-mail software package. If the recipient is a secure mail system subscriber, the recipient's public key is retrieved from the secure mail system data base in step S 15-12. If the recipient is not known as a subscriber to the secure mail system, a password or passphrase taken from the sender e-mail message is used as a seed to generate a public/private key pair in step S-15-13. This step permits the non-subscriber recipient to receive an e-mail message that can be opened by entry of the proper password or passphrase, obtained through separate communication channels from the sender. If the recipient subscribes to a third party e-mail software package, a third party form e-mail service message is generated in step S-15-14 to provide the recipient with a seamless integration with the secure mail system. Once a public key is obtained in steps S-15-13 or S-15-12, as shown in step S-15-16, the random symmetrical one time key is encrypted with the public key in step S-15-9, to produce an encrypted random symmetrical one time key 905. If the recipient does not use a third party e-mail service, secure mail package 901 is prepared with encrypted expanded reformatted mail message 903, encrypted random symmetrical one time key 905, secure mail system digital signature 911, recipient's public key 909 and encrypted secure mail system public key 907. The entire package is then sent as an e-mail message to the recipient. If the recipient is a subscriber to a third party e-mail service, then the sender message is simply reformatted according to the third party e-mail service protocol, and sent to the third party e-mail service for processing, and subsequent delivery to the recipient.

Referring now to FIG. 10, secure mail system package 901 is encapsulated in an e-mail message according to whether the recipient is a secure mail system subscriber or not. Decision S-10-1 determines whether the recipient is a secure mail system subscriber, and if so branches to step S-10-2 to process secure mail system package 901 as a special form e-mail file shown in step S-10-3. The generated special form e-mail file from step S-10-3 is provided as an attachment to a secure mail system message in step S-10-4, after which the e-mail message is ready to be sent in step S-10-8. If the recipient is not a subscriber to the secure mail system, secure mail system package 901 is encapsulated as a special executable file in step S-10-5. The special executable file shown in step S-10-6 is attached to an e-mail message in step S-10-7, and is then ready for sending in step S-10-8.

If the recipient is identified as a user of a third party e-mail system, third party e-mail message format 913 is readied for transmission according to the third party software protocol in step S-10-9, and is then ready for sending in step S-10-8.

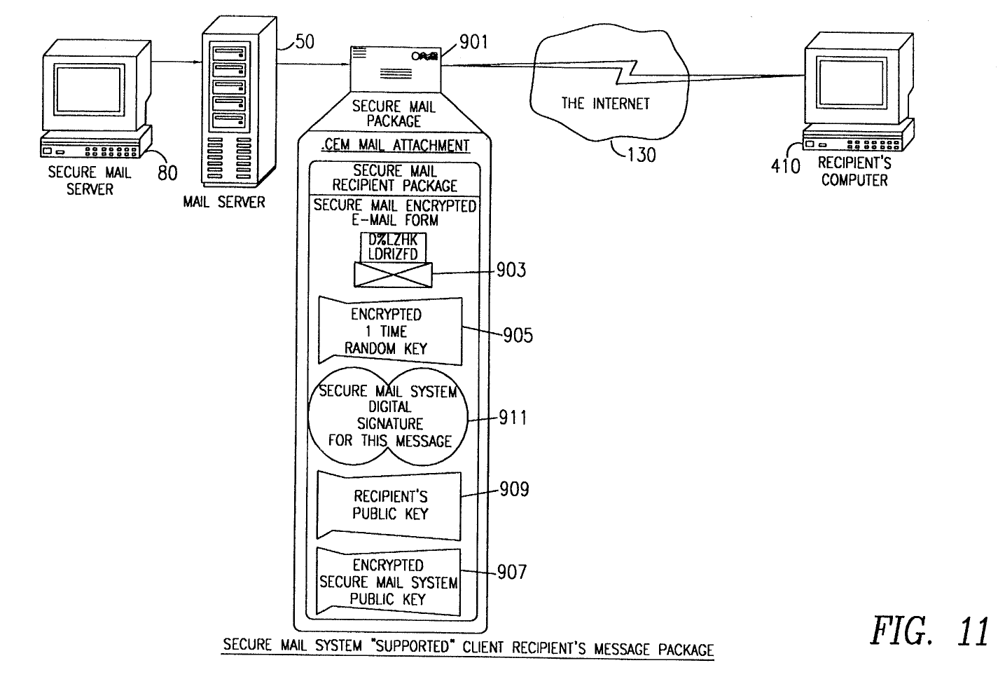

Referring now to FIG. 11, the process of transmission of secure mail system package 901 to a recipient using a supported mail platform is shown. Secure mail system package 901 is provided by secure mail server 80 to mail server 50 for transmission to subscriber recipient 410 over communication network 130. The user at subscriber recipient 410 is notified of the secure mail message in their e-mail system inbox and selects the message to open the file. The secure mail system software resident on the computer of subscriber recipient 410 executes to unpack secure mail system package 901. Encrypted random symmetric one time key 905 is decrypted with a private key assigned to subscriber recipient 410. Once the random symmetric one time key is decrypted, it is used to decrypt encrypted expanded reformatted message 903, in addition to decrypting encrypted secure mail system public key 907. Once the expanded reformatted message is decrypted, a hashing algorithm is applied to the message to generate a digital hash code. The digital hash code and the secure mail system public key are combined to verify secure mail system digital signature 911. If verification of secure mail system digital signature 911 fails, an error message is generated and processing terminates. Otherwise, the expanded reformatted message is transformed into a form suitable for use by the resident e-mail software used by subscriber recipient 410. This completed transmission of the original sender e-mail message from sending computer 400 can be acknowledged with a return receipt that can be generated once the e-mail message is verified and used at subscriber recipient 410. The return receipt can be in the form of an e-mail that is directed back to the sender through secure mail system server 80 in a process reverse to that described for the sender message.

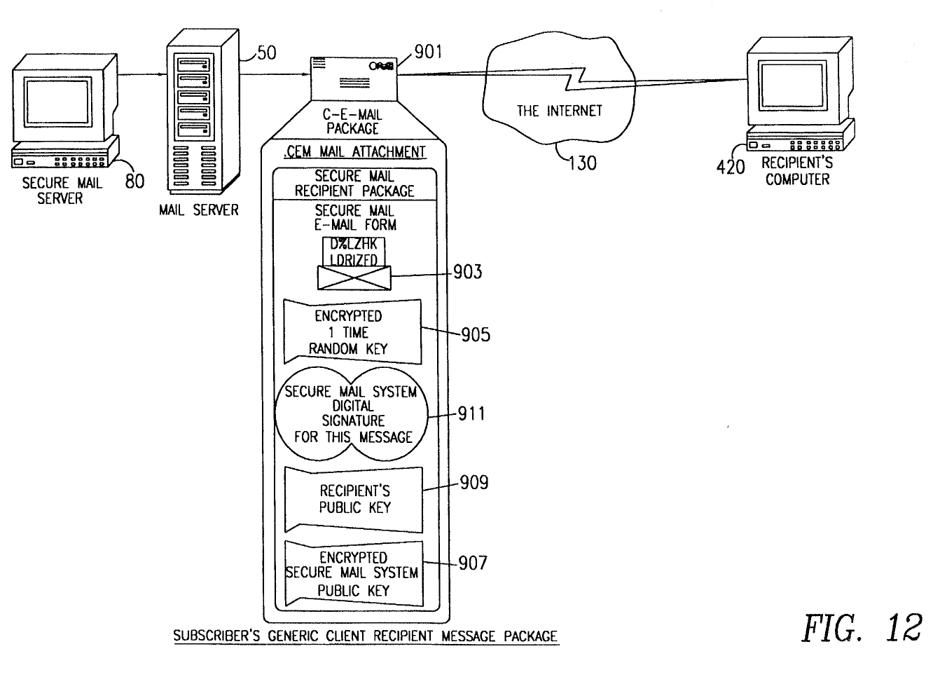

Referring now to FIG. 12, a process for transmission of secure mail system package 901 to subscriber recipient 420 that uses a web based or unsupported e-mail system is shown. Secure mail system package 901 as assembled by secure mail system server 80 is transferred to mail server 50 for transmission to subscriber recipient 420 over communication network 130. The user at subscriber recipient 420 is notified of the arrival of a new e-mail in their inbox, and can select the message for viewing. Upon selection, resident secure mail system software executes to retrieve and unpack the contents of secure mail system package 901. A private key obtained from subscriber recipient 420 is used to decrypt encrypted random symmetrical one time key 905. Once the random symmetrical one time key is unencrypted, encrypted expanded reformatted message 903 and encrypted secure mail system public key 907 can both be unencrypted using the random symmetrical one time key. The unencrypted expanded reformatted message has a hashing algorithm applied to produce a digital hash code. The secure mail system public key is combined with the digital hash code to verify secure mail system digital signature 911. If secure mail system digital signature 911 cannot be verified, an error message is generated and processing of secure mail system package 901 ceases. Otherwise, secure mail system digital signature 911 is validated and the expanded reformatted message is displayed to the user of subscriber recipient 420. Again, it is possible to send a return receipt to the message sender at sending computer 400, communicating that the message was properly received and read, or that an error occurred in transmission from mail server 50 to subscriber recipient 420. The return receipt message can be in the form of an e-mail transmitted to the sender at sending computer 400, in a process reverse to that described for sending of the original e-mail message, i.e., via secure mail server 80.

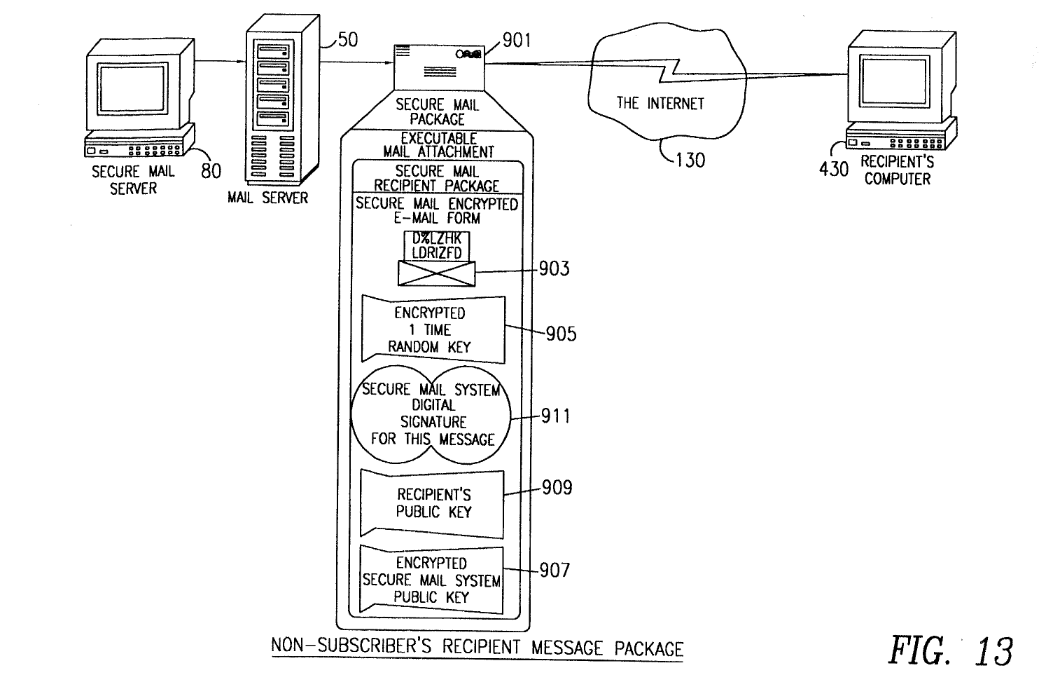

Referring now to FIG. 13, a diagram of the transmission of secure mail system package 901 to non-subscriber recipient 430 is shown. Secure mail system package 901 originates at secure mail server 80 on the second leg of the secure transmission path according to the present invention. Secure mail system package 901 is transferred to mail server 50, for transmission to nonsubscriber recipient 430 over communication network 130. The user of nonsubscriber recipient 430 is notified of receipt of an incoming e-mail message and can select the message for display. When the received message is displayed, it contains instructions describing operations needed to access and display the encapsulated secure mail message. The user activates the encapsulated executable file, which immediately prompts the user for a password, or a passphrase. The user enters a password or a passphrase, which is then used to generate a public/private key pair. The generated public key is compared with recipient public key 909 to verify the proper password or passphrase used to generate the public/private key pair. The password or passphrase is typically communicated to the recipient user through another familiar communication channel, such as face-to-face conversation, telephone, facsimile, and so forth. The user is permitted up to three attempts to enter the correct password or passphrase needed to generate the correct matching public key of the public/private key pair. Once the correct public key has been generated through entry of the correct password or passphrase, the associated private key is used to decrypt encrypted random symmetrical one time key 905. Once the random symmetrical one time key is decrypted, it is used to unencrypt encrypted expanded reformatted message 903 and encrypted secure mail system public key 907. The unencrypted expanded reformatted message is subjected to a hashing algorithm to produce a digital hash code for use in verification and authentication of the message. The digital hash code is combined with the unencrypted secure mail system public key to verify secure mail system digital signature 911. If the verification fails, an error message is generated and the processing of secure e-mail system package 901 ceases. The error message can include, for instance, a message indicating that secure mail system package 901 was somehow corrupted in transmission between mail server 50 and non-subscriber recipient 430. If the verification of secure mail system digital signature 911 succeeds, the unencrypted e-mail message is displayed in a generic format to the user. Once again, a return receipt can be provided to inform the sender that the e-mail message was successfully sent and received in proper form. Alternatively, a return receipt message can indicate if there were any problems in transmission of the e-mail message, including failed digital signature authentication, the existence of a virus in the message or an inappropriate secure mail system public key, for instance. The return receipt message can be in the form of a secure e-mail that is transmitted over a return route similar to the reverse of the original e-mail message path. Secure processing of the return receipt message would follow the same process as described for the originally sent message, but in reverse.

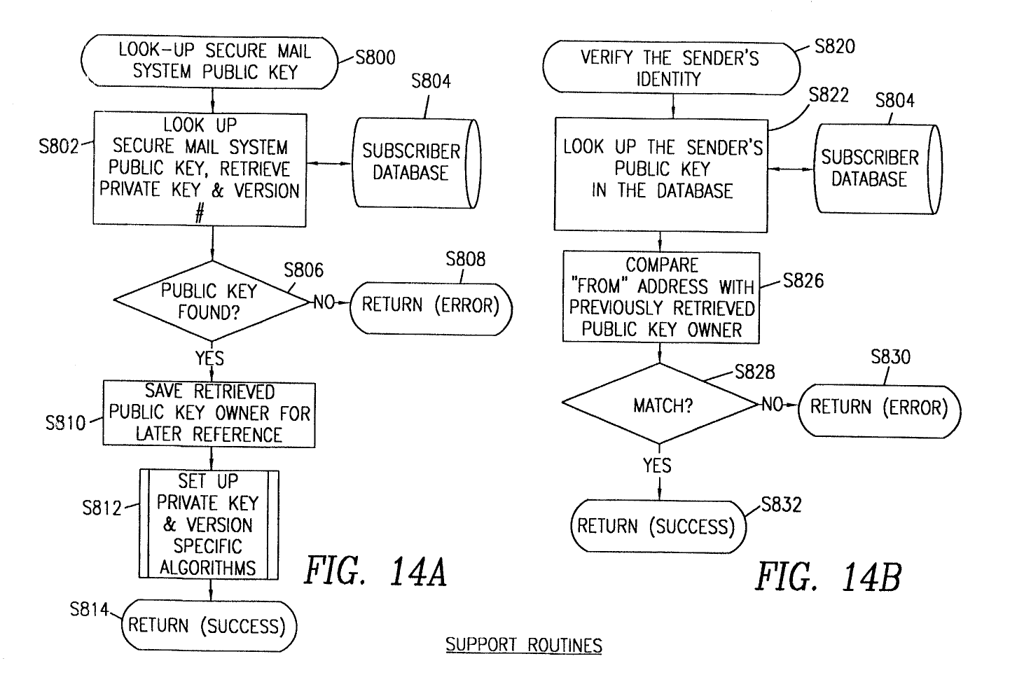

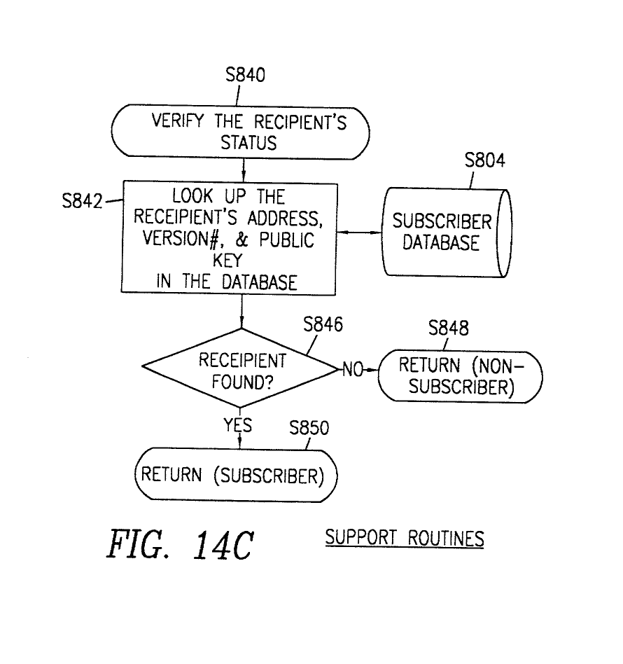

Referring now to FIG. 14, several support routines used by secure mail server 80 in unpacking and checking secure mail system package 900 are shown. The support routine shown in FIG. 14A is provided to verify any public key encapsulated in a sent secure e-mail, as indicated in step S-800. The secure mail system uses the secure mail system public key as a look up parameter to retrieve a matching secure mail system private key along with a version number in step S802. The look up is performed on subscriber data base S804, which holds public/private key pairs and accompanying version numbers. If a match for the public key look up was found in subscriber data base S804, as determined in step S806, the algorithm continues to step S810 in which information related to the owner of the public key is saved for a later reference. If the public key is not found in subscriber data base S804, indicating a corrupted secure mail system public key, or a message that it is potentially compromised, decision step S806 branches to return an error in step S808. The returned error from the routine is used to notify a sender or an operator that a sent e-mail message is potentially corrupted or compromised in some fashion.

Once a match for the public key is found in subscriber data base S804, and the algorithm branches at decision step S806 to continue with step S810, the private key that forms the complementary pair of public/private keys is retrieved from subscriber data base S804 along with an associated version number, and is used to set up algorithms to unpack and verify an incoming secure mail message, as illustrated, for instance, in FIG. 8. The successful matching of the secure mail system public key in subscriber data base S804, and subsequent retrieval of the paired private key results in a successful conclusion and return in the algorithm shown in step S814.

Referring now to FIG. 14B, an algorithm for use with verifying a sender's identity is shown. Beginning with step S820. Once the algorithm is entered through step S820, the sender's public key is applied in step S822 to subscriber data base S804 to retrieve the sender identity associated with the public key used as the look up tag. The subscriber information matching the sender's public key is retrieved from subscriber data base S804 and compared with the sender information contained in the secure mail message in step S826. If the identity stored in subscriber data base S804 matches that of the sender specified in the secure mail message, as determined in decision step S828, the algorithm concludes successfully in step S832. Otherwise, decision step S828 branches to return an error in step S830. The returned error from step S830 can be used to notify an operator that an error has occurred in matching a reported subscriber identity. Upon being alerted, an operator can take action to verify the subscriber information, notify a subscriber of the error, or take steps to determine whether the subscriber's ID was attempted to be used in an unauthorized fashion.

Referring now to FIG. 14C, an algorithm for verifying subscription status of a recipient is illustrated, beginning with step S840. Once the algorithm is entered through step S840, the recipient's identity is applied in step S842 to subscriber data base S804 to verify subscriber recipient information. If the application of the recipient's identity to subscriber data base S804 results in a match, as illustrated in decision step S846, the recipient information is retrieved from subscriber data base S804 and returned to the calling procedure in step S850. If the recipient is not found in subscriber data base S804, decision step S846 branches to return an indication that the recipient is a non-subscriber and step S848. The results of the algorithm shown in FIG. 14C are used to determine the method by which the retransmitted secure mail package components will be encrypted, as illustrated in FIG. 9. For example, if the algorithm in FIG. 14C returns with an indication of a non-subscriber recipient in step S848, a public/private key pair is generated using a password or a passphrase provided by the sender, as illustrated in step S-15-13 in FIG. 9. If the recipient is determined to be a subscriber as illustrated in step S850, the recipient's public key is retrieved from subscriber data base S804 and used to encrypt the random symmetrical one time key, as illustrated in FIG. 9, steps S15-12 and S-15-9.

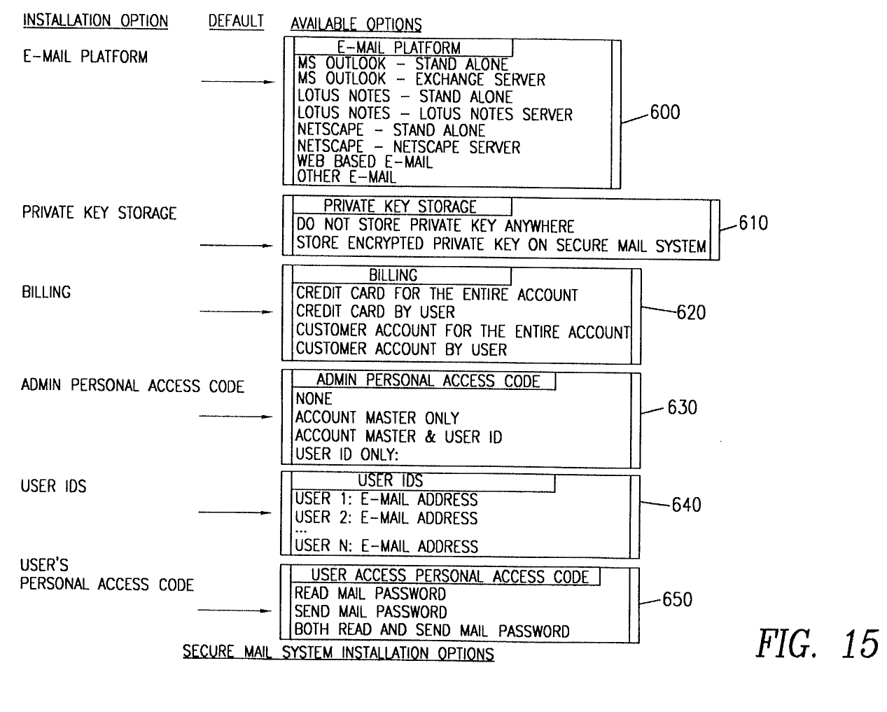

Referring now to FIG. 15, a table of menu options illustrating installation options for the secure mail system according to the present invention is shown. Upon installation of the resident software for operation of the secure mail system according to the present invention, the user is presented with a number of options to properly set up the system according to their needs and desires. A first option selectable by the user is illustrated in menu table 600, wherein the user can choose the e-mail platform preferred. The e-mail platforms listed in menu table 600 are supported by the secure mail system according to the present invention. For example, the secure mail system according to the present invention provides a transparent interface for the user for the widely used programs MS OUTLOOK, either stand alone or exchange server versions, LOTUS NOTES, either stand alone or LOTUS NOTES server version, NETSCAPE, either stand alone or NETSCAPE server version. A user that already has one of these supported e-mail platforms of MS OUTLOOK, LOTUS NOTES or NETSCAPE will continue to see the same application interface for their e-mail platform. In these instances where the e-mail platform is supported by the secure mail system according to the present invention, the user is presented with a simple add on function in an obtrusive but easily accessible portion of the user interface, for instance.

Alternatively, the user can select a web based e-mail platform, or other e-mail platforms that may not necessarily be supported. As described above, the secure mail system according to the present invention can be used with any type of e-mail system and hardware/software platform combinations with only minor variations in the way the user interacts with their preferred, potentially unsupported e-mail system.

A menu table 610 describes selections available for the user upon installation of the secure mail system software for storage of private keys. According to a preferred embodiment of the present invention as described above, it is not necessary to store the user's private key anywhere, but instead the public/private key pair for encyrption/decryption can be generated through a number of devices or mechanisms whenever needed to encrypt/decrypt a secure mail message. According to this embodiment, the user's private key is only stored in volatile memory, such as Random Access Memory (RAM), for example, whenever a public/private key pair needs to be generated to encrypt/decrypt a secure mail message. Therefore, according to this embodiment the private key enjoys heightened security by being securely regenerated whenever needed, and is never stored in a fixed media format.

According to options provided to the user on installation, the unstored private key can be generated according to various criteria, including such events as login or when the e-mail system is activated. Other options allow the user's password or pass phrase used to generate the private key to be “forgotten,” i.e., the user must reenter the password or pass phrase after a time-out, for example, or upon the occurrence of a secure event, such as receipt of a secure message.

In an alternate embodiment of the present invention, the private key can be generated or stored in encrypted form by secure mail server 80, for instance. In this embodiment, the private key is generated, or the encrypted private key is retrieved from subscriber database S804, for example, and decrypted, and the private key applied to incoming and outgoing secure mail messages for verification and encryption/decryption. In this embodiment, as with the above discussed embodiment in which the user's private key is not stored anywhere, the user is protected from having their e-mail system potentially compromised by, for example, having their portable computer or wireless device stolen.

Because the system according to the present invention can be used on an individual or enterprise wide basis, for example, a number of billing options are provided for custom tailoring to the user's needs as shown in menu table 620. As illustrated in menu table 620, the user can select the installation option of entering a credit card number to be billed for secure mail transactions, in which one credit card account can be used for multiple users, or separate credit card accounts can be used for each individual user. In addition, a user can be identified by a customer account that is maintained by the secure mail system according to the present invention as illustrated in FIG. 3, for example. The billing for a customer account can be set up to have a single account for an entire enterprise, or single accounts for each individual user, or combinations thereof. It should be apparent that a number of versions of the secure mail system according to the present invention can be provided to accommodate a number of different billing schemes, such as monthly, on a transaction basis, or even billing on a no fee basis.

During installation, options can be selected for administration of the resident secure mail system, as illustrated in menu table 630. During installation the system can be set up to permit anyone access on an administrative basis, access to a master administrator of the selected account, access to the administrative master and the particular user, or only the particular user. These features provided in menu table 630 allow optional administration schemes, such as over a network, or on a remote basis, in addition to local and automated administration. In a preferred embodiment, only an administrative master is permitted administrative access to the user set up.

During installation the resident secure mail system can be set up to have multiple user IDs as illustrated in menu table 640. For example, a user ID related to access of various external systems, including such systems as listserves, can be set up on a specific basis. Alternately, user IDs related to specific tasks, for example, can be maintained for organizational purposes. Preferably, a single user ID is set up on installation of the resident's e-mail system.

A user also provides upon installation a personal access code as shown in menu table 650. The personal access code entered during installation according to menu table 650 can be used as the password or passphrase that generates a public/private key pair when sending a secure mail message to a non-subscriber recipient, as illustrated in step S-15-13 in FIG. 9. Various options for personal access codes can be enabled, for instance to provide different levels of access to secure mail transmissions. For example a personal access code can be entered to permit the user to only read secure mail messages, or a personal access code can be entered to permit the user to only send secure mail messages, or a combination of both, as is preferred.

It should also be apparent that each of the installation options described in FIG. 15 can be set in an installation script that can run automatically upon installation of the resident secure mail system on a user's computer. For instance, if a user's computer is connected to a network, an automated installation script can reside on a central server of the network, and be used at each individual station in which a resident secure mail system is installed. It should also be apparent that each of the installation settings can be modified by a user, administrator, or automatically depending upon selected options. As a simple example, the user may be prompted to modify their personal access code over a set interval of time, such as every sixty days.

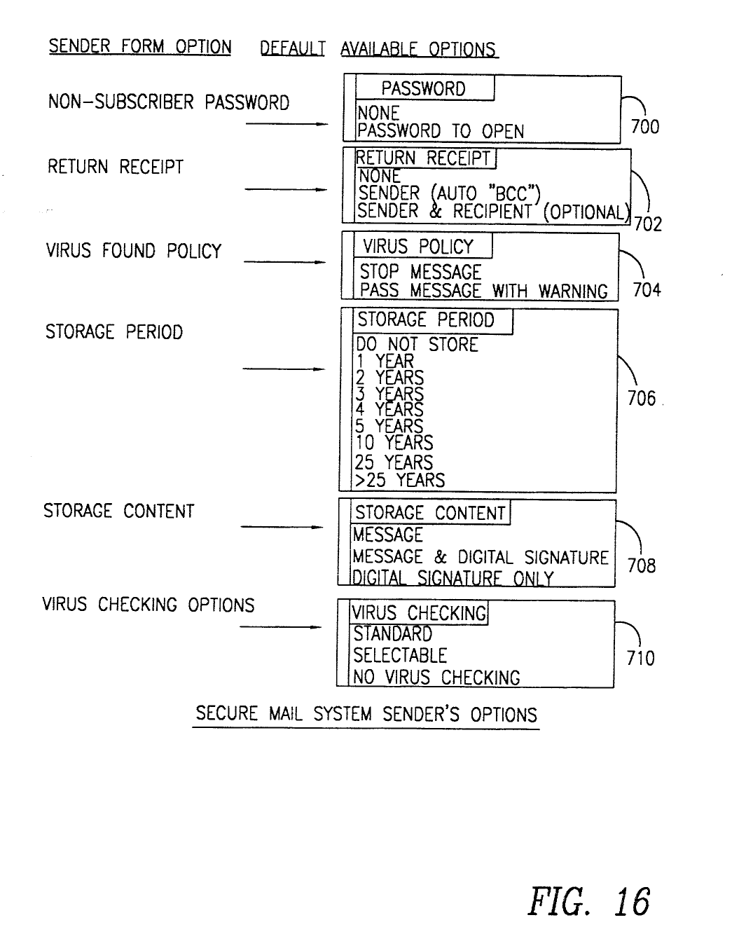

Referring now to FIG. 16, a set of options for a sender of a secure mail message is illustrated. The sender options are activated once the sender chooses to begin composing a secure mail message from their e-mail program. If the sender is using an unsupported e-mail platform, the sender's options are activated once the user selects the secure mail system for transmission of a message composed according to the user's e-mail platform. Option 700 permits the sender to select a password or a pass phrase that must be entered to open the e-mail message upon receipt by a recipient. Preferably, the user enters a password to further protect the message upon transmission. Option 702 permits the sender to select a return receipt notification once the transmitted message is received and opened by the intended recipient. The sender can select no return receipt, a return receipt only for the sender, or a return receipt for the sender and notification to the recipient. Preferably, a return receipt to the sender is provided.

Sender option 704 dictates the handling of a message that has been determined to contain a virus. The sender can select the option of stopping message altogether, or passing the message onto the recipient with an attached warning notifying the recipient of the detected virus. Preferably, the option for stopping the message is selected.

Sender option 706 illustrates a selection of storage criteria for the secure mail message once it has been verified and is ready for resending at central server 52 (FIG. 1). The user can select a variety of storage periods, including non-storage of the message. According to this option, messages that have been previously transmitted can be reverified, along with a time date stamp and other information related to their transmission, even after a number of years have passed. Option 708 describes the contents of the stored message that the sender wishes to have maintained. The sender can select to have the message alone stored, as is preferred, or the message and associated digital signature, or simply the digital signature alone. Accordingly, the sender can select appropriate storage needs depending on the application for which secure mail messages are transmitted.

The sending user can also select virus checking options as shown in option 710. Preferably, standard virus checking is enable. Optionally, the user can select from among various virus checking programs according to their desires and needs. In addition, the user can select no virus checking to be done, in which case the original message sent by the user is not decrypted, but only the random symmetrical one time key packaged with the message as sent. The option of having no virus checking can potentially permit messages that are intended to be modified during transmission, or for the secure transmission of programs identified as viruses, to permit analysis thereof, for example.

According to the present invention a transmission between a sender and a receiver can be completed with confidentiality, virus protection, tamper proofing, authentication using digital signatures and time date authentication. All these features are available according to the present invention, while at the same time minimizing changes to the user's interface for sending e-mail messages. The time date stamp is driven by an atomic clock and is highly accurate. The secured message can be stored for extended periods of time and reverified at a point in the future if necessary. The system according to the present invention also operates on the transmitted e-mail message only in volatile memory, and is never stored in a more tangible or fixed medium, thus preventing operation such as an inadvertent backup, copy or saved version of a secure message. The system according to the present invention works with any e-mail system, and provides additional functionality for supported and widely used e-mail systems. If a recipient e-mail system is unsupported or unknown, the secure mail message is simply provided as a password or pass phrase accessible attachment that can be opened by the recipient having the appropriate password or pass phrase.

In addition, according to the present invention, the sender can receive a secure, digitally signed, time/date stamped copy of the message received by the recipient. Alternatively, the sender can receive a return receipt notification that is again secure, digitally signed and time date stamped, notifying the sender that the transmitted e-mail message was received. The system also prevents propagation of viruses while still using secure transmission methods, and notifying the sender that a virus was detected in the transmitted message.

The system according to the present invention provides advantages over prior systems and achieves a high level of security and reliability. For example, unlike fax transmissions, the time/date stamp on the secure mailed message according to the present invention is tamper proof and not susceptible to manipulation by a third party. The e-mail message can be scanned for viruses in its native format, rather than “hiding” a virus that can be potentially encrypted with a message sent using typical e-mail systems. For example, a typical firewall setup will not detect a virus embedded in an encrypted file, but rather pass the message directly to the recipient. The present invention, in contrast, can detect a virus in a transmitted message and prevent propagation of the message, while informing the sender of the message status.

The system according to the present invention further provides protection against activity monitoring by never including the end-to-end correspondence in the secure message transmission at the same time. Instead, only the sender is identified in a sent message that is received by the secure mail system, and only a recipient is identified in a message retransmitted from the secure mail system. Accordingly, if an eavesdropper wished to track activity between two parties, they would be unsuccessful in tracking communications between parties using the system according to the present invention. Each secure mail transmission is also digitally signed using a highly unique digital hash code to ensure the message has not been tampered with and to authenticate the transmitting and receiving parties. It should be apparent that the present invention is not limited to the embodiments described herein, but rather is applicable to a number of scenarios in which it is desired to have secure messages transmitted. For example, funds can be transferred in electronic form in a secure fashion with a high level of security and reliability. Senders and receivers of secure fund transmissions will instantly know whether any errors have occurred in the transmission of data, or whether a transmission has been tampered with in any way.

As another example, the popularity of third party hosted websites for use with resource intensive projects can benefit from the present invention by providing a high level of confidentiality, security and reliability to third party operators and customers. For example, it is known that parties to a litigation may share information required by law through a third party website that has the available resources to handle large volumes of documents and a variety of security access levels.

In the same vein, professionals in the medical, accounting and legal arts can benefit from secure and confidential exchange of documents that are required to be verified, or have the potential for future verification. For example, a medical file on a patient can be transmitted on a world wide basis, while being maintained private and free from tampering.

Other areas in which the present invention would be highly advantageous include law enforcement, journalism, financial services, and generally any type of operation in which a sender and recipient wish to have private secure communication.

It should be apparent that the present invention is not limited to communication systems involving computers, but can also include such applications as remote electronic entry, in which a user can request entry to a building or vehicle, for example, by sending a secure wireless transmission to an appropriate service that can automatically unlock the desired entrance. In a situation such as this, the sender can be verified, the authorization for entry can be authenticated and verified and any attempts at tampering or redirection can be identified and recorded. In addition, a log of individuals accessing secured areas can be maintained.

It should be further apparent that the present invention is not limited to applications involving security issues only, but is generally applicable to situations involving electronic commerce. These applications include commercial websites used for marketing raw materials, in which a supplier and customer must be verified prior to confirmation of a transaction taking place. Furthermore, electronic commerce examples in which the present invention is useful can include such items as ordering merchandise on line, to using a wiring device to select items from a vending machine.

It should also be apparent that the present invention is applicable where non-active systems are in use. For example, a user provided with a passive security card that is read by an active device can employ the system according to the present invention to authenticate the user, verify appropriate access, and other security related features. As another example, a user may take advantage of a hybrid device that contains passive and active elements, whereby a passive portion of a device can be read by a “recipient” device, and the active portion of the device can be modified by the recipient device to permit an exchange to validate secure authorization. Such systems can be employed, for example, with services available to the public, such as pay phones, vending machines, fuel purchases, and so forth.

The foregoing description of the preferred embodiments of the present invention has been provided for the purpose of illustration and description. It is not intended to be exhaustive or to limit the invention to the precise forms disclosed. Many modifications and variations are possible in view of the above teaching. It is thus intended that the scope of the invention not be limited to this detailed description, but rather to the claims appended hereto.

What is claimed is:

1. A secure communication system, comprising:
a first communication station;
a secure communication signal generated at a first communication station;
a second communication station coupled to said first communication station, said second communication station being effective to receive said secure communication signal;
said second communication station being operable to verify a content of said secure communication signal and generate a verified secure communication signal; and
a third communication station coupled to said second communication station, said third communication station being effective to receive said verified secure communication signal.

2. A secure communication system according to claim 1, further comprising:
a sender public/private key pair;
a first unique authentication signal related to said content and said sender private key from said sender public/private key pair; and
said secure communication signal further comprises said first authentication signal.

3. A secure communication system according to claim 2, further comprising:
a first random encryption key provided at said first communication station;
a first encryption engine operable to process at least one of said content and said sender public key from said sender public/private key pair with said first random encryption key to provide an encrypted communication signal; and
said secure communication signal comprises said encrypted communication signal.

4. A secure communication system according to claim 3, further comprising:
a system public/private key pair;
said encryption engine being further operable to process said first random encryption key with said system public key from said system public/private key pair to provide a first encrypted random key; and
said secure communication signal further comprises said first encrypted random key.

5. A secure communication system according to claim 2, further comprising:
a volatile memory storage at said first communication station; and
said sender public/private key pair extant in said volatile memory storage.

6. A secure communication system according to claim 5, further comprising:
a public/private key pair generator having an input;
a user selectable code suitable for application to said input of said public/private key pair generator; and
said sender public/private key pair being an output of said public/private key pair generator and being related to said user selectable code.

7. A secure communication system according to claim 6, further comprising:
an individual specific code generator device;
said code generator device operable to process a characteristic of an individual to provide said user selectable code.

8. A secure communication system according to claim 1, further comprising:
an electronic messaging program operable with said first communication station; and
a secure electronic messaging program operable with said electronic messaging program to accept input therefrom and provide said secure communication signal.

9. A secure communication system according to claim 8, further comprising:
an option selection program for said secure electronic messaging program; and
said option selection program provides selectable options accessible to permit a user to select options related to operation of said secure electronic messaging program.

10. A secure communication system according to claim 9, wherein said option selection program is a portion of an installation program operable to install said secure electronic messaging program in at least one of said first and third communication stations.

11. A secure communication system according to claim 9, wherein said selectable options include at least one of an option for storing or not storing a sender private key from a sender public/private key pair and an option for entry of a pass code.

12. A secure communication system according to claim 9, wherein:
said selectable options include control options for controlling aspects of said secure communication signal; and
said control options including at least one of whether a virus should be passed with a said secure communication or not, whether said content should be stored or not and whether said first authentication signal should be stored or not.

13. A secure communication system according to claim 1, further comprising:
an electronic sender address identifying a user at said first communication station;
an electronic station address identifying said second communication station; and
said secure communication signal is addressed from said sender address to said station address.

14. A secure communication system according to claim 13, further comprising:
at least one electronic receiver address identifying a user at said third communication station; and
said verified secure communication signal is addressed from said station address to said at least one receiver address.

15. A secure communication system according to claim 1, further comprising:
an electronic station address identifying said second communication station;
at least one electronic receiver address identifying a user at said third communication station; and
said verified secure communication signal is addressed from said station address to said at least one receiver address.

16. A secure communication system according to claim 2, further comprising:
a hashing engine coupled to said first communication station;
said hashing engine being operable to process said content to provide a hash code; and
a combination of said hash code and said sender private key from said sender public/private key pair provides said first authentication signal.

17. A secure communication system according to claim 1, wherein said first communication station further comprises a hash code generator;
said hash code generator being operable to generate a hash code related to said content;
a sender private key from a sender public/private key pair;
said hash code and said sender private key being combined to provide a first authentication signal; and
said secure communication signal further comprises said first authentication signal.

18. A secure communication system according to claim 1, wherein said second communication station further comprises a chronometric indicia mechanism being operable to provide chronometric indicia suitable for insertion in said content, whereby a time and date of receipt of said secure communication signal at said second communication station can be indicated in said verified secure communication signal.

19. A secure communication system according to claim 1, wherein said second communication station further comprises a virus checking engine;
said virus checking engine being operable to scan said content for software viruses; and
a result of said scan provides said verification of said content.

20. A secure communication system according to claim 19, wherein said virus checking engine is further operable to scan said secure communication signal for software viruses and remove a virus detected by said scan.

21. A secure communication system according to claim 2, wherein said verification is based on said first authentication signal.

22. A secure communication system according to claim 1, further comprising:
a system public/private key pair;
a second unique authentication signal related to a content of said verified communication signal and said system private key from said system public/private key pair; and
said verified secure communication further comprises said second authentication signal.

23. A secure communication system according to claim 2, further comprising:
a system public/private key pair;
a second unique authentication signal related to a content of said verified communication signal and said system private key from said system public/private key pair; and
said verified secure communication further comprises said second unique authentication signal.

24. A secure communication system according to claim 1, further comprising:
a random encryption key provided at said second communication station;
an encryption engine operable to process at least one of a content of said verified secure communication signal and a system public key from a system public/private key pair with said random encryption key to provide an encrypted verified communication signal; and
said verified secure communication signal comprises said encrypted verified communication signal.

25. A secure communication system according to claim 3, further comprising:
a second random encryption key provided at said second communication station;
a second encryption engine operable to process at least one of a content of said verified secure communication signal and a system public key from a system public/private key pair with said second random encryption key to provide an encrypted verified communication signal; and
said verified secure communication signal comprises said encrypted verified communication signal.

26. A secure communication system according to claim 24, further comprising:
a recipient public/private key pair;
said encryption engine being further operable to process said random encryption key with said recipient public key from said recipient public/private key pair to provide an encrypted random key; and
said verified secure communication signal comprises said encrypted random key.

27. A secure communication system according to claim 25, further comprising:
a recipient public/private key pair;
said second encryption engine being further operable to process said second random encryption key with said recipient public key from said recipient public/private key pair to provide an encrypted random key; and
said verified secure communication signal comprises said encrypted random key.

28. A secure communication system according to claim 26, wherein said recipient public/private key pair is provided by a public/private key pair generator based on an input user selectable code.

29. A secure communication system according to claim 27, wherein said recipient public/private key pair is provided by a public/private key pair generator based on an input user selectable code.

30. A secure communication system according to claim 1, further comprising:
a firewall at said second communication station;
said firewall operable to at least one of block unauthorized communications, detect viruses and remove viruses.

31. A secure communication system according to claim 1, further comprising:
a volatile memory storage at said second communication station; and
said content of said secure communication signal extant in said volatile memory storage.

32. A secure communication system according to claim 1, further comprising:
a return receipt issued by said second communication system; and
said return receipt indicates receipt of said verified secure communication signal at said third communication station.

33. A secure communication system according to claim 1, further comprising:
a load balancer at said second communication station;
said load balancer coupled to a plurality of system nodes; and
said load balancer can determine processing loads on said system nodes, whereby said secure communication signal can be routed to an appropriate system node to facilitate efficient processing.

34. A secure communication system according to claim 1, further comprising:
a database coupled to said second communication station; and
said database provides a cross reference between sender public/private key pairs or between subscriber identifying information and a subscriber public key.

35. A secure communication system according to claim 1, further comprising:
a record of secure communication transactions; and
a reporting engine operable to provide reports related to said record.

36. A secure communication method, comprising:
securing a message at a first location;
transmitting said secure message to a second location;
receiving said secure message at said second location;
verifying a content of said secure message at said second location; and
transmitting said verified, secure message to a third location.

37. A secure communication system, comprising:
a sending device effective to originate an electronic message;
a security producing operator coupled to said sending device and operable to produce a secure message based on said electronic message;
a communication network coupled to said sending device, said communication network operable to transmit said secure message;
a central processor coupled to said communication network and effective to receive said secure message from said communication network;
said central processor being operable to verify a content of said secure message;
said central processor being further operable to transmit said verified secure message to said communication network;
a receiving device coupled to said communication network and operable to receive said verified secure message from said communication network; and
a security removing operator coupled to said receiving device and operable to reproduce said electronic message from said verified secure message.

38. A secure communication system, comprising:
a sending device;
a receiving device;
a transmission medium;
a security mechanism coupled to each of said sending and receiving devices; and
said security mechanism being operable to transform at least one of a secure message and an unsecure message to an unsecure message and secure message, respectively, whereby said sending and receiving devices can communicate unsecure messages originating from at least one of said sending and receiving devices as secure messages over said transmission medium, and said security mechanism being further operable to provide authentication of said secure messages.

39. A method for secure communication, comprising:
operating on an unsecure transmission signal to produce a secure transmission signal including an authenticating code;
transmitting said secure transmission signal;
receiving said secure transmission signal;
operating on said secure transmission signal to produce said unsecure transmission signal; and
verifying said received unsecure transmission signal using said authenticating code.

40. A method for secure communication, comprising:
operating on an unsecure transmission signal at a sender to produce a secure transmission signal;
transmitting said secure transmission signal to a verification operator;
receiving said secure transmission signal at said verification operator;
operating on said secure transmission signal at said verification operator to verify a content of said secure transmission signal;
transmitting said verified secure transmission signal to a receiver;
receiving said verified secure transmission signal at said receiver; and
operating on said verified secure transmission signal at said receiver to produce said unsecure transmission signal.

41. A secure communication system, comprising:
an encryption/decryption operator coupled to a plurality of communication devices;
said plurality of communication devices coupled together across a communication medium;
said encryption/decryption operator including an encryption/decryption code generator;
said encryption/decryption operator is effective to transform unsecure communications to secure communications and vice-versa through application of an encryption/decryption code provided by said encryption/decryption code generator; and
at least one of said communication devices is configured with:
an input to receive said secure communications;
said encryption/decryption operator effective to transform said received secure communications to received unsecure communications;
a verification processor operable to verify a content of said received unsecure communications in combination with said encryption/decryption code;
said encryption/decryption operator effective to transform said verified unsecure communication to a verified secure communication; and
an output to transmit said verified secure communication to at least one other communication device.

42. A method for secure communication, comprising:
generating a random encryption key;
encrypting a communication signal with said random encryption key;
encrypting said random encryption key;
transmitting a secure communication signal comprising said encrypted communication signal and said encrypted random encryption key;
receiving said secure communication signal;
decrypting said random encryption key;
decrypting said encrypted communication signal with said random encryption key; and
verifying a content of said received, decrypted communication signal.
